(19) United States
(12) Patent Application Publication
(10) Pub. No.: US 2026/0330534 A1
(43) Pub. Date: Oct. 22, 2026

(54) INTERACTIVE GROCERY PLATFORM

(71) Applicant: Tasteful Co., Jackson, WY (US)

(72) Inventors: Michael Frank, Indian Trail, NC (US); Maxim Sindall, Toronto (CA); Andre Rush, Alexandria, VA (US); Meer Liyaquat Ali, Oakville (CA); Matthew Stanley Piotrowski, Tampa, FL (US)

(21) Appl. No.: 19/643,534

(22) Filed: Apr. 9, 2026

Related U.S. Application Data
(60) Provisional application No. 63/791,311, filed on Apr. 18, 2025.

(51) Int. Cl. G06Q 30/0601; G06F 3/04842; G06F 16/335; G06N 20/00

(52) U.S. Cl. CPC G06Q 30/0633; G06F 3/04842; G06F 16/335; G06N 20/00

(57) ABSTRACT

Methods, devices, and systems that support an interactive grocery platform are described herein. A server associated with a content platform may receive user preferences and location information from a device. The server may obtain inventory information for one or more grocery stores and may transmit, to the device, one or more recipes that are associated with the user preferences. The server may receive a selection of one or more recipes to include in a meal plan and may train a model for generating meal plans based on interactions between a user of the device and the one or more recipes. The server may transmit a second meal plan to the user based on the trained model and may generate a shopping list based on the inventory information. The shopping list may be transmitted to the device.

### CROSS REFERENCE

The present Application for Patent claims the benefit of U.S. Provisional Patent Application No. 63/791,311 by Frank et al., entitled “INTERACTIVE GROCERY PLATFORM,” filed Apr. 18, 2025, assigned to the assignee hereof, and expressly incorporated by reference herein.

### FIELD OF TECHNOLOGY

The present disclosure relates generally to database systems and data processing, and more specifically to interactive grocery platform.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. Users may access the cloud platform using various user devices (e.g., desktop computers, laptops, smartphones, tablets, or other computing systems, etc.).

In one example, the cloud platform may support streaming services (e.g., content platforms). For example, the cloud platform may support platforms that allow users access to content (e.g., via applications, such as mobile applications) related to shopping (e.g., grocery shopping), meal preparation and planning, and the like. A user may utilize the cloud platform to engage with such platforms, services, and content. For example, a user may engage with the cloud platform to shop for various goods and services online.

### BRIEF DESCRIPTION OF THE DRAWINGS

FIG. 1 illustrates an example of a system that supports an interactive grocery platform in accordance with aspects of the present disclosure.

FIGS. 2–7 show examples of flowcharts that support an interactive grocery platform in accordance with aspects of the present disclosure.

FIGS. 8 and 9 show examples of block diagrams that support an interactive grocery platform in accordance with aspects of the present disclosure.

FIG. 10 shows a block diagram of a content platform that supports an interactive grocery platform in accordance with aspects of the present disclosure.

FIG. 11 shows a diagram of a system including a device that supports an interactive grocery platform in accordance with aspects of the present disclosure.

FIG. 12 shows a flowchart illustrating methods that support interactive grocery platform in accordance with aspects of the present disclosure.

### DETAILED DESCRIPTION

Meal planning, grocery shopping, and meal preparation may be a burdensome exercise. For example, meal plans may need to account for factors such as dietary restrictions, cultural and religious beliefs, food preferences, and the like. When extrapolated over multiple individuals (e.g., members of a family), various factors may need to be considered. Although resources exist to account for some of these factors, such resources may be decentralized and make grocery shopping difficult. For example, various cookbooks and websites exist to account for dietary restrictions, but may not account for other factors. Moreover, compiling grocery lists when obtaining recipes from various sources may be burdensome and time consuming. If all of these challenges are overcome, preparing meals poses its own set of challenges. For example, many recipes found online (and all recipes found in cookbooks) include only a listing of ingredients and a written description about how to prepare the recipe. That is, such recipes may not include any interactive resources such as audio dictation, video tutorials, or the like, which facilitates the preparation of the meal. Accordingly, due to the difficulties in modern meal planning, grocery shopping, and meal preparation, a centralized content platform to streamline these tasks and processes may be desirable.

A centralized content platform that facilitates meal planning, grocery shopping, and meal preparation is described herein. For example, the content platform may implement an adaptive multi-constraint artificial intelligence (AI) meal planning system to streamline these tasks and processes. The content platform may include or otherwise support dynamic recipe modification with flavor profile preservation, cross-store shopping optimization with cost-benefit analysis, and context-aware cooking guidance with skill progression tracking. Additionally or alternatively, the content platform may utilize implicit preference learning from tracking user interactions to provide (e.g., recommend) personalized recipes, meal plans, and the like to users. Such recommendations may account for dietary restrictions, cultural and religious beliefs, food preferences, and the like, for multiple individuals in a family (e.g., a bigger family size).

Moreover, the content platform may analyze grocery store inventory information to provide shopping lists and recommend grocery stores having relative low costs (or costs with a defined budget range). The content platform may also integrate online grocery shopping to serve as a centralized hub for all meal planning, grocery shopping, and meal preparation tasks. Additionally or alternatively, the content platform may support integrated dietary restriction processing with ingredient substitution to further optimize meal planning and preparation. In some instances, the content platform may provide multimedia content (e.g., audio dictation, video tutorials) to aid a user in food preparation. Accordingly, the system herein may streamline processes and reduce time and expenses incurred due to otherwise burdensome planning, grocery shopping, and meal preparation processes.

Aspects of the disclosure are initially described in the context of an environment supporting an on-demand database service. Aspects of the disclosure are further illustrated by and described with reference to apparatus diagrams, system diagrams, and flowcharts that relate to an interactive grocery platform.

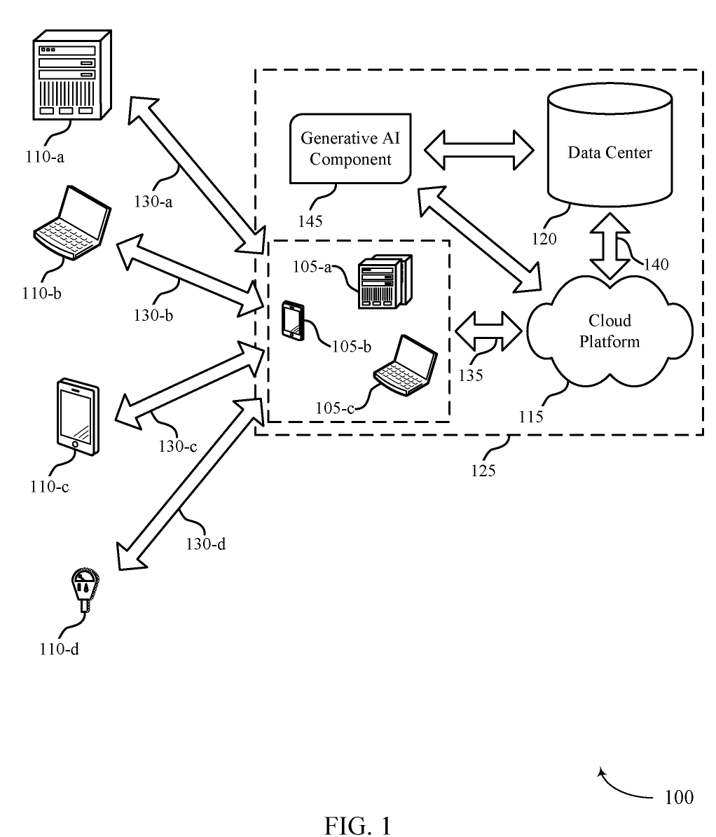

FIG. 1 illustrates an example of a system 100 for cloud computing that supports an interactive grocery platform in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Content platform 125 may include cloud clients 105, cloud platform 115, and data center 120. In some cases, data processing may occur at any of the components of content platform 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some examples, the system 100 may include a generative artificial intelligence (AI) component 145. The generative AI component 145 may be an example or a component of a large language model (LLM), such as a generative AI model. In some examples, the generative AI component 145 may additionally, or alternatively, be referred to as any of an AI, a generative AI (GAI), a GAI model, an LLM, a machine learning model, or any similar terminology. The generative AI component 145 may be a model that is trained on a corpus of input data, which may include text, images, video, audio, structured data, or any combination thereof. Such data may represent general-purpose data, domain-specific data, or any combination thereof. Further, the generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may input a prompt to the generative AI component 145 that includes, or otherwise indicates, the query (or information included therein). The generative AI component 145 may generate an output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located external to the content platform 125. However, the generative AI component 145 may be hosted on the cloud platform 115, elsewhere within the content platform 125, or outside the content platform 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

In various implementations, the models and/or modules described herein (e.g., including, but not limited to, the generative AI component 145) may be classification, predictive, generative, conversational, or another form of AI technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology’s output with the set of documents or knowledge base.

To further guide and train output of the AI technology, one or more input prompts may be provided to the AI technology for the purpose of eliciting particular responses. In various implementations, the input prompts may correspond to the particular field or task to which the AI technology is trained. Additionally, or alternatively, the AI technology may be implemented along with one or more additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

Meal planning, grocery shopping, and meal preparation may be a burdensome exercise. For example, meal plans may need to account for factors such as dietary restrictions, cultural and religious beliefs, food preferences, and the like. When extrapolated over multiple individuals (e.g., members of a family), various factors may need to be considered. Although resources exist to account for some of these factors, such resources may be decentralized and make grocery shopping difficult. For example, various cookbooks and websites exist to account for dietary restrictions, but may not account for other factors. Moreover, compiling grocery lists when obtaining recipes from various sources may be burdensome and time consuming. And if all of these challenges are overcome, preparing meals poses its own set of challenges. For example, many recipes found online (and all recipes found in cookbooks) include only a listing of ingredients and a written description about how to prepare the recipe. That is, such recipes may not include any interactive resources such as audio dictation, video tutorials, or the like, which facilitates the preparation of the meal. Accordingly, due to the difficulties in modern meal planning, grocery shopping, and meal preparation, a centralized content platform 125 to streamline these tasks and processes may be desirable.

The content platform 125 may be a centralized content platform 125 that facilitates meal planning, grocery shopping, and meal preparation. For example, the content platform 125 may implement an adaptive multi-constraint AI meal planning system to streamline these tasks and processes that utilizes the generative AI component 145 to perform one or more of the processes described herein. The content platform 125 may include or otherwise support dynamic recipe modification with flavor profile preservation, cross-store shopping optimization with cost-benefit analysis, and context-aware cooking guidance with skill progression tracking. Additionally or alternatively, the content platform 125 may utilize implicit preference learning from tracking user interactions to provide (e.g., recommend) personalized recipes, meal plans, and the like to users. Such recommendations may account for dietary restrictions, cultural and religious beliefs, food preferences, and the like, for multiple individuals in a family (e.g., a family size).

Moreover, the content platform 125 may analyze grocery store inventory information to provide shopping lists and recommend grocery stores having relative low costs (or costs with a defined budget range). The content platform 125 may also integrate online grocery shopping to serve as a centralized hub for all meal planning, grocery shopping, and meal preparation tasks. Additionally or alternatively, the content platform 125 may support integrated dietary restriction processing with ingredient substitution to further optimize meal planning and preparation. In some instances, the content platform 125 may provide multimedia content (e.g., audio dictation, video tutorials) to aid a user in food preparation. Accordingly, the system herein may streamline processes and reduce time and expenses incurred due to otherwise burdensome planning, grocery shopping, and meal preparation processes.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

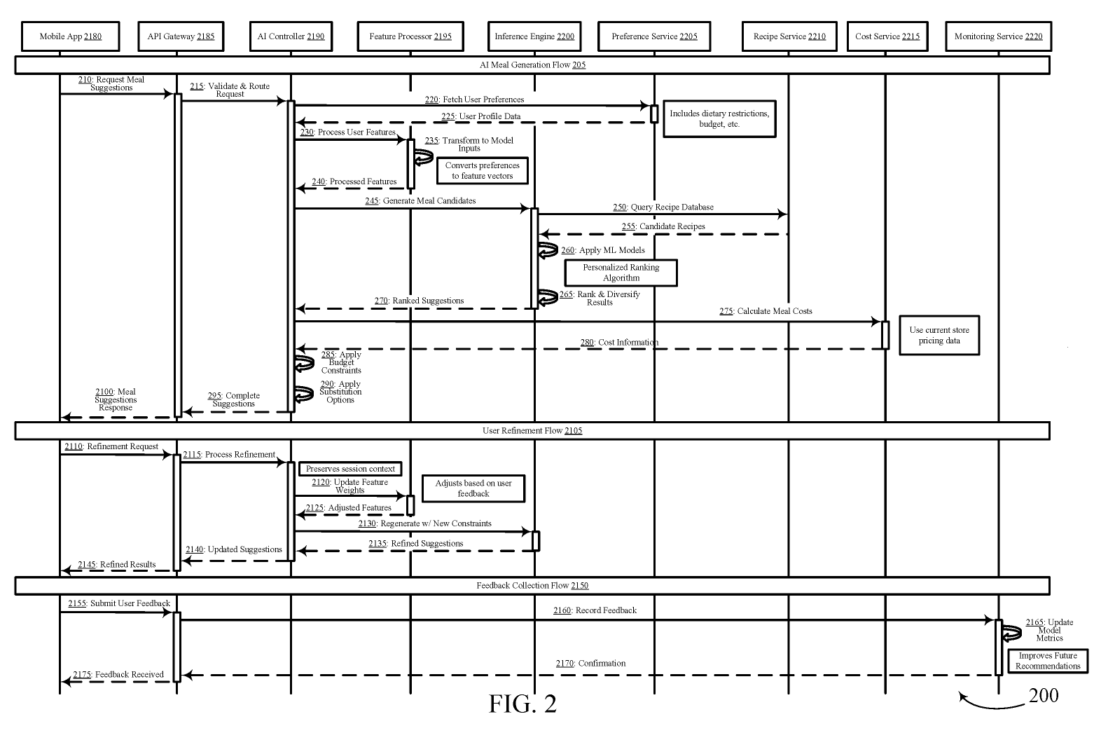

FIG. 2 shows an example of a flowchart 200 that supports an interactive grocery store platform in accordance with one or more aspects of the present disclosure. In some examples, the flowchart 200 may implement, or be implemented by, aspects of the system 100. Operations of the flowchart 200 may be performed by a system including a mobile application 2180, an API gateway 2185, an AI controller 2190, a feature processor 2195, an inference engine 2200, a preference service 2205, a recipe service 2210, a cost service 2215, and a monitoring service 2220.

In some instances, aspects of the flowchart 200 may be implemented by a content platform 125, cloud client 105, and/or the contacts 110 as described with reference to FIG. 1. For example, the AI controller 2190 may be an example of, or may perform the similar features as the AI component 145. For example, content platform 125 (or one or more of its components) described with reference to FIG. 1 may implement the API gateway 2185, the AI controller 2190, the feature processor 2195, the inference engine 2200, the preference service 2205, the recipe service 2210, the cost service 2215, and/or the monitoring service 2220. In some cases, the mobile application 2180 may be an example of aspects of the mobile application 2180 that are implemented by the content platform 125. A mobile application (such as mobile application 2180) may have aspects that are implemented on a local device (such as a contact 110 and/or a cloud client 105) and aspects that are implemented cloud architectures (e.g., the content platform 125). Additionally or alternatively, the mobile application 2180 may be an example of an application installed and running on any of a server (e.g., cloud client 105-a), a smartphone (e.g., cloud client 105-b), a laptop (e.g., cloud client 105-c), or any suitable electronic device or the contacts 110.

The APIs described herein may include a set of protocols that allows different software applications to communicate with each other. APIs may enable the integration of different systems, allowing them to work together and share functionalities without having to understand the internal workings of each other. In some cases, the APIs described herein may be examples of interfaces defined by creators of a given application to allow other applications to interact with the given application. In some cases, an API may be an example of a system that scrapes data associated with the application. For example, a web scraper may gather data from a website (e.g., a website of a grocery store or other retailer), may organize the information and may store that information. In such an example, the API may refer to information that results from the scraping or may refer to both the resulting information and the protocols used to scrape the information from the other application(s). In some examples, an API may not be provided directly by a grocery store or other entity. In such examples, the content platform 125 (or some other application or entity associated with the content platform 125) may “scrape” the associated data via one or more web crawling applications. The web crawling applications may store (e.g., to a server) the product data. The data may be stored in such a way that an API or some other set of protocols may be defined to recall the data for use by the content server 125.

In the following description of the flowchart 200, the operations between the mobile application 2180, the API gateway 2185, the AI controller 2190, the feature processor 2195, the inference engine 2200, the preference service 2205, the recipe service 2210, the cost service 2215, and the monitoring service 2220 may occur in a different order than the example order shown and, in some examples, may be performed by one or more different components other than those shown as examples. Some operations also may be omitted from the flowchart 200, and other operations may be added to the flowchart 200. Further, although some operations may be shown to occur at different times for discussion purposes, these operations may actually occur at the same time.

The mobile application 2180, the API gateway 2185, the AI controller 2190, the feature processor 2195, the inference engine 2200, the preference service 2205, the recipe service 2210, the cost service 2215, and the monitoring service 2220 may perform operations of an AI meal generation flow 205 to provide meal suggestions to a user.

At 210, a user may submit a request for meal suggestions via the mobile application 2180, and the API gateway 2185 may receive the request. For instance, the user may select a button associated with AI meal generation via a UI of a user device that has downloaded the mobile application 2180. At 215, the API gateway 2185 may validate the user request and route the user request to the AI controller 2190.

At 220, the AI controller 2190 may fetch user preference information from the preference service 2205. The user preference information may include dietary restrictions, budget constraints, preferred cuisines, ingredients to include, ingredients to exclude, cooking skill level, a user location, or any other user preferences. At 225, the preference service 2205 may output, to the AI controller 2190, user profile data including the user preference information.

At 230, the AI controller 2190 may send one or more user features to the feature processor 2195 for processing. In some aspects, the one or more user features may be user preferences based on the user preference information fetched at 220. At 235, the feature processor 2195 may transform the one or more user features into model inputs for use in one or more AI algorithms or ML models. For example, the feature processor 2195 may convert user preferences into feature vectors. In some cases, generation of feature vectors based on user preferences at 235 may be performed as part of (e.g., or in support of) a multi-parameter matching algorithm. At 240, the feature processor 2195 may output the processed features to the AI controller 2190.

At 245, the AI controller 2190 may input the processed features into the inference engine 2200 to prompt the inference engine 2200 to generate a set (e.g., one or more) of suggested meals (e.g., meal candidates). At 250, the inference engine 2200 may query a recipe database associated with the recipe service 2210 to support generation of the set of suggested meals. For instance, the recipe database may store a plurality of recipes, and the recipe service 2210 may select a set of candidate recipes from the plurality of recipes. In some aspects, the recipe service 2210 may select the set of candidate recipes from the plurality of recipes based on user preference constraints (e.g., based on the processed features). At 255, the recipe service 2210 may output the set of candidate recipes to the inference engine 2200.

At 260, the inference engine 2200 may apply one or more ML models to the processed features, the set of candidate recipes, or a combination thereof to generate the set of suggested meals. For example, the inference engine 2200 may apply the multi-parameter matching algorithm to the feature vectors (e.g., based on the user preferences) generated at 235. The multi-parameter matching algorithm may, in some cases, include generation of recipe embeddings of meal candidates (e.g., the set of candidate recipes) and comparison of the recipe embeddings. The multi-parameter matching algorithm may support verification that one or more constraints (e.g., user preferences associated with the processed features) are satisfied, calculation of a relevance score for the meal candidates, or a combination thereof. In some implementations, the inference engine 2200 may apply contextual recommendation enhancement. The contextual recommendation enhancement may be integrated into the multi-parameter matching algorithm and applied to the processed features, the meal candidates, or the combination thereof. Additionally, or alternatively, the contextual recommendation enhancement may be implemented by a separate ML model and applied to the set of suggested meals. The contextual recommendation enhancement may include prioritization of seasonal ingredients, suggestion of weather-appropriate meals, adjustments based on time-of-day relevance, detection of special occasions, or any combination thereof.

At 265, the inference engine 2200 may rank and diversify results (e.g., outputs, the set of suggested meals, meal candidates) of the one or more ML models. For instance, the inference engine 2200 may rank the set of suggested meals based on the relevance of each suggested meal to the user (e.g., based on the user preferences). The inference engine 2200 may, in some examples, use a personalized (e.g., based on the user preferences) ranking algorithm to rank the set of suggested meals. In some cases, the inference engine 2200 may implement a diversity enforcement system, which may assure recipe variety, monitor a nutritional balance of the set of suggested meals, prevent ingredient repetition, implement cuisine rotation scheduling, or a combination thereof. In some aspects, the diversity enforcement system may be implemented by an ML algorithm. At 270, the inference engine 2200 may output the set of suggested meals and the associated ranking to the AI controller 2190.

At 275, the AI controller 2190 may prompt the cost service 2215 to calculate meal costs associated with the set of suggested meals. In some aspects, the cost service 2215 may use current store pricing data to calculate the meals costs associated with the set of suggested meals. At 280, the cost service 2215 may output cost information associated with the set of suggested meals to the AI controller 2190.

At 285, the AI controller 2190 may apply budget constraints (e.g., included in the user preferences) to the suggested meals using the cost information provided by the cost service 2215, user budget constraints fetched from the preference service 2205 at 220, or both. For example, the AI controller 2190 may filter out or flag one or more suggested meals from the set of suggested meals based on the one or more suggested meals exceeding a user budget constraint (e.g., or causing a total cost of the set of suggested meals to exceed a user budget constraint).

At 290, the AI controller 2190 may apply substitution options for one or more ingredients of one or more suggested meals included in the set of suggested meals. For instance, the AI controller 2190 may flag the one or more suggested meals at 285 for exceeding a user budget constraint, and the AI controller 2190 may swap one or more ingredients of the one or more suggested meals for one or more less expensive ingredients to satisfy the user budget constraint. In some aspects, the AI controller 2190 may apply the substitution options in accordance with an ingredient substitution algorithm. The ingredient substitution algorithm may include functional property matching, flavor profile preservation (e.g., to ensure that a substitute ingredient may taste similar to an original ingredient), one or more nutritional equivalence calculations, allergen safety verification, cost optimization, or any combination thereof to determine one or more substitute ingredients that share similar qualities with one or more original ingredients.

In some implementations, the AI controller 2190 may apply the ingredient substitution algorithm as part of a larger recipe adaptation system that dynamically modifies recipes based on user constraints (e.g., user preferences). The recipe adaptation system may further include a portion scaling engine, a cooking method transformer, or both, which the AI controller 2190 may apply at 290 to further modify one or more suggested meals of the set of suggested meals. The portion scaling engine may perform nonlinear quantity adjustments, cooking time recalculations, equipment requirement adaptations, yield prediction modeling, or any combination thereof to modify (e.g., or scale) a suggested recipe for a different portion size. The cooking method transformer may perform equivalent method generation, equipment-based adaptations, time constraint optimization, difficulty level adjustments, or any combination thereof to dynamically modify a suggested recipe to meet user constraints such as a user skill level, cooking equipment owned by the user, and available time of the user.

At 295, the AI controller 2190 may output the set of suggested meals to the API gateway 2185. For instance, the AI controller 2190 may output a complete list of suggested meals after applying budgets constraints and substitution options. At 2100, the API gateway 2185 may send a meal suggestions response to the mobile application 2180. The meal suggestions response may include the set of suggested meals. In some examples, the mobile application 2180 may support display of the meal suggestions response at a UI of a user device.

In some implementations, the AI meal generation flow 205 may also generate a grocery list associated with the set of suggested meals, which may be provided to the user via the mobile application 2180 along with the set of suggested meals. For instance, a shopping list generation engine may create one or more optimized grocery lists associated with the set of suggested meals based on an ingredient consolidation algorithm, store section organization, a list optimization protocol, or any combination thereof. The ingredient consolidation algorithm may detect and merge duplicate ingredients (e.g., ingredients common to multiple suggested meals), convert and normalize units of ingredients (e.g., to standardize units of ingredients across suggested meals), perform quantity optimization, account for a pantry inventory (e.g., ingredients already in the user’s possession), or any combination thereof.

Information about a pantry may be gathered and/or maintained in a variety of different ways. A pantry inventory may include any food owned by a user and may include items in a pantry, a fridge, a freezer, cabinets, on shelves, and/or stored in any location. In some examples, a user may manually input a listing of items in their possession (e.g., in his or her pantry). In other examples, the user may capture a photo or video of one or more items and, using image recognition, the content platform 125 may identify the items. The content platform 125 may compare a photo or video of the items to photos in a photo database to determine one or more characteristics of the item (e.g., an item type, a size, a brand, etc.). Additionally or alternatively, the user may scan a machine-readable representation of data in a visual format (e.g., scan a barcode or QR code) of one or more items and the content platform 125 may identify the items. For example, the content platform 125 may utilize a database to determine one or more characteristics of the item (e.g., an item type, a size, a brand, etc.) based on scanning the item’s barcode. In each of the aforementioned examples, the content platform 125 may utilize the listing of items (e.g., in the user’s pantry) to detect and merge duplicate ingredients (e.g., ingredients common to multiple suggested meals), convert and normalize units of ingredients (e.g., to standardize units of ingredients across suggested meals), perform quantity optimization, or any combination thereof.

In some examples, the content platform 125 may refrain from adding ingredients the user already possesses to grocery lists. In other examples, the generative AI component 145 may learn a user’s shopping habits based on the provided information and may utilize such information when training the model (e.g., to provide customized recipes and meal plans). The generative AI component 145 may track the items the user owns, the items the user purchases, and/or the items the user uses in cooking (based on the recipes selected for a meal plan) to anticipate when an item is running low and automatically add the item to a subsequent shopping list.

Additionally or alternatively, the generative AI component 145 may analyze one or more nutritional characteristics (e.g., calories, fat content, etc.) associated with the items the user possesses. The generative AI component 145 may recommend healthier alternatives to the items the user owns, recommend more affordable alternatives to the items the user owns, recommend sales and coupons local stores may be running or promoting (e.g., based on the inventory information received from one or more grocery stores), estimate a value of the items the user owns and provide analysis of the user’s positive or negative shopping habits and how their habits can be improved, or any combination thereof. For example, the system may advise on available items based on grocery story inventory, family size, prices, available coupons, current sales, various ingredient alternatives, healthier alternatives, or any combination thereof.

The shopping list generation engine may perform store section organization by performing aisle-based grouping of ingredients, adapting grocery lists to a store-specific layout, performing category-based classification of ingredients, performing efficient routing optimization, or any combination thereof. The list optimization protocol may apply user brand preferences, perform size or package optimization, identify opportunities for bulk purchases, perform seasonal availability adaptation (e.g., adapt grocery lists based on which ingredients are available seasonally), or any combination thereof.

The mobile application 2180, the API gateway 2185, the AI controller 2190, the feature processor 2195, the inference engine 2200, the preference service 2205, the recipe service 2210, the cost service 2215, and the monitoring service 2220 may perform operations of a user refinement flow 2105 to refine meal suggestions (e.g., the set of suggested meals) provided to the user. The user refinement flow 2105 may be implemented as part of a preference learning system that continuously updates user preference models (e.g., the one or more ML models applied by the inference engine 2200). In some aspects, the user refinement flow 2105 may support a preference model update protocol that includes incremental model refinement, a confidence scoring system, preference stability assessment, conflicting signal resolution, or any combination thereof.

At 2110, the user may submit a refinement request via the mobile application 2180, and the refinement request may be received by the API gateway 2185. For instance, the user may adjust one or more user preferences to refine the meal suggestions provided by the AI meal generation flow 205. At 2115, the API gateway 2185 may send the refinement request to the AI controller 2190 for processing.

At 2120, the AI controller 2190 may prompt the feature processor 2195 to update one or more feature weights based on the refinement request. For example, the feature processor 2195 may adjust the one or more user features and associated weights based on user feedback (e.g., the user adjusting the one or more user preferences). In some aspects, the feature processor 2195 may preserve a session context when performing updating of the one or more feature weights. At 2125, the feature processor 2195 may output the adjusted one or more user features and associated weights to the AI controller 2190.

At 2130, the AI controller 2190 may send the adjusted one or more user features and associated weights to the inference engine 2200 and prompt the inference engine 2200 to regenerate the set of suggested meals in accordance with one or more new constraints (e.g., the adjusted one or more features and associated weights). For example, the inference engine 2200 may input the adjusted one or more user features and associated weights into the multi-parameter matching algorithm to generate an updated set of suggested meals. At 2135, the inference engine 2200 may output the updated set of suggested meals (e.g., refined suggestions) to the AI controller 2190. At 2140, the AI controller 2190 may output the updated set of suggested meals (e.g., updated suggestions) to the API gateway 2185. At 2145, the API gateway 2185 may output the updated set of suggested meals (e.g., refined results) to the mobile application 2180. For example, the mobile application 2180 may support display of the updated set of suggested meals via a UI of a user device.

The mobile application 2180, the API gateway 2185, the AI controller 2190, the feature processor 2195, the inference engine 2200, the preference service 2205, the recipe service 2210, the cost service 2215, and the monitoring service 2220 may perform operations of a feedback collection flow 2150 to collect user feedback on a set of suggested meals provided by the AI meal generation flow 205 or the user refinement flow 2105. The feedback collection flow 2150 may be implemented as part of the preference learning system. In some aspects, the feedback collection flow 2150 may support explicit feedback processing that includes rating normalization algorithms, analysis of sentiments expressed by the user in reviews of suggested meals, extraction of feature importance, contradiction resolution, or any combination thereof. Additionally, or alternatively, the feedback collection flow 2150 may support an implicit signal collection mechanism that include interaction pattern analysis, tracking of durations for which the user views suggested recipes, modeling of selection behavior, detection of abandonment patterns (e.g., a user abandoning or failing to execute a suggested recipe), or any combination thereof.

At 2155, the API gateway 2185 may receive user feedback submitted or communicated via the mobile application 2180. The user feedback may be explicit feedback submitted by the user via a UI (e.g., a UI of a user device that has downloaded the mobile application 2180), implicit signaling (e.g., patterns or suggested recipes selected or abandoned by the user, view durations of suggested recipes, patterns of user interaction with suggested recipes, etc.), or any combination thereof. At 2160, the API gateway 2185 may output the user feedback to the monitoring service 2220, and the monitoring service 2220 may record (e.g., store) the user feedback.

At 2165, the monitoring service 2220 may update one or more model metrics (e.g., associated with the one or more ML models, for example the one or more ML models applied by the inference engine 2200) based on the user feedback. The updating of the model metrics may improve future recommendations (e.g., suggested meals) provided to the user. At 2170, the monitoring service 2220 may output, to the API gateway 2185, an indication confirming that user feedback has been received by the monitoring service 2220, that the one or more model metrics have been updated, or both. At 2175, the API gateway 2185 may output, to the mobile application 2180, an indication that the user feedback has been received. In some examples, the mobile application 2180 may support display of the indication that the user feedback has been received at a UI of a user device.

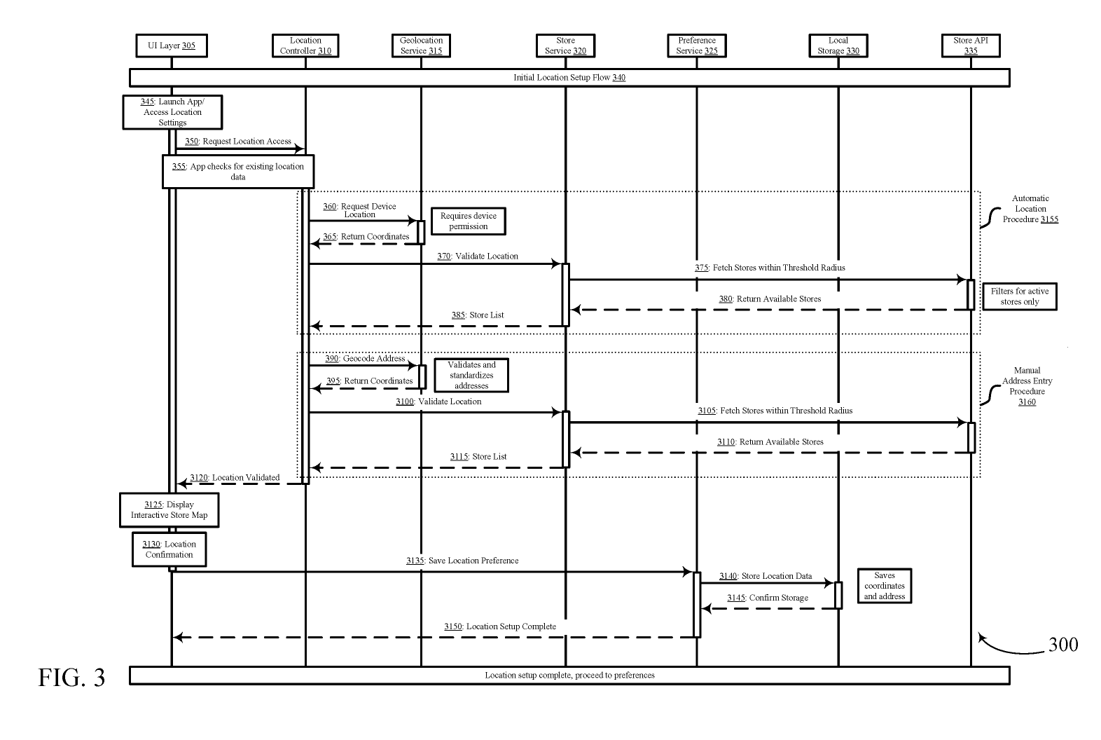

FIG. 3 shows an example of a flowchart 300 that supports an interactive grocery store platform in accordance with one or more aspects of the present disclosure. In some examples, the flowchart 300 may implement, or be implemented by, aspects of the system 100 and the flowchart 200. Operations of the flowchart 300 may be performed by a system including a UI layer 305, a location controller 310, a geolocation service 315, a store service 320, a preference service 325, a local storage 330, and a store API 335. In some instances, aspects of the flowchart 300 may be implemented by a content platform 125 as described with reference to FIG. 1. For example, the content platform 125 may include or otherwise support a UI layer 305, a location controller 310, a geolocation service 315, a store service 320, a preference service 325, a local storage 330, and a store API 335.

In the following description of the flowchart 300, the operations between the UI layer 305, the location controller 310, the geolocation service 315, the store service 320, the preference service 325, the local storage 330, and the store API 335 may occur in a different order than the example order shown and, in some examples, may be performed by one or more different components other than those shown as examples. Some operations also may be omitted from the flowchart 300, and other operations may be added to the flowchart 300. Further, although some operations may be shown to occur at different times for discussion purposes, these operations may actually occur at the same time.

The location controller 310, the geolocation service 315, the store service 320, the preference service 325, the local storage 330, and the store API 335 may perform operations of an initial location setup flow 340 to establish a user location and nearby stores (e.g., grocery stores or other locations where a user may obtain ingredients for suggested meals).

At 345, a user may launch an app (e.g., the mobile application 2180 as described with reference to FIG. 2), access a location settings screen, or both via the UI layer 305. At 350, the UI layer may request the location controller 310 for location access. At 355, the app may interact with the UI layer 305 and the location controller 310 to check for existing location data associated with the user (e.g., or a user device associated with the UI layer 305). If the app determines that the app does not have existing location data, the app may perform an automatic location procedure 3155 or a manual address entry procedure 3160 to determine stores near the user location. In some aspects, the app may request location access via the location controller 310, and the user may allow automatic location detection or manually enter an address via the UI layer 305. For instance, the UI layer 305 may display a prompt asking for automatic location detection for view by the user, and the user may select a “yes” option or a “no” option to determine whether to allow automatic location detection.

If the app has permission from the user device to perform automatic location detection, the app may perform the automatic location procedure 3155. At 360, the location controller 310 may request a location of the user device from the geolocation service 315. At 365, the geolocation service 315 may output coordinates associated with the location of the user device based on the user device permitting automatic location detection (e.g., configured in setting of the user device). In some aspects, the geolocation service 315 may validate the coordinates associated with the location of the user device. At 370, the location controller 310 may send the coordinates to the store service 320 and prompt the store service 320 to validate the location of the user device and determine nearby stores.

At 375, the store service 320 may fetch stores within a threshold radius (e.g., a 10 mile radius) of the location of the user device from the store API 335. That is, the store service 320 may query the store API 335 for available stores within the threshold radius. In some examples, the store API 335 may filter for active stores (e.g., stores that are currently open). At 380, the store API 335 may output (e.g., return) a list of the available stores to the store service 320. At 385, the store service 320 may output the list of the available stores to the location controller 310.

If the app lacks permission from the user device to perform automatic location detection, or if the user manually inputs an address, the app may perform the manual address entry procedure 3160. At 390, the location controller 310 may send a geocode address manually entered by the user to the geolocation service 315. At 395, the geolocation service 315 may output coordinates associated with the location of the user device based on validating and standardizing the geocode address. At 3100, the location controller 310 may send the coordinates to the store service 320 and prompt the store service 320 to validate the geocode address and determine nearby stores.

At 3105, the store service 320 may fetch stores within a threshold radius (e.g., a 10 mile radius) of the geocode address from the store API 335. That is, the store service 320 may query the store API 335 for available stores within the threshold radius. In some examples, the store API 335 may filter for active stores (e.g., stores that are currently open). At 3110, the store API 335 may output (e.g., return) a list of the available stores to the store service 320. At 3115, the store service 320 may output the list of the available stores to the location controller 310.

At 3120, the location controller 310 may indicate to the UI layer 305 that the location of the user device (e.g., or the geocode address) has been validated. In some examples, the location controller 310 may send the list of the available stores returned at 385 or 3115 to the UI layer 305. At 3125, the UI layer 305 may display (e.g., at a UI of the user device) an interactive store map based on the list of the available stores and the location of the user device. In some examples, the interactive store map may display the available stores and the location of the user device in a map. The interactive store map may, in some cases, provide directions or routing information associated with travelling between available stores and the location of the user device. At 3130, the user may confirm the location of the user device via the UI layer 305. In some aspects, the user may confirm the location of the user device based on the display of the interactive store map at 3125.

At 3135, the UI layer 305 may send the location of the user device to the preference service 325, and the preference service 325 may save a location preference associated with the location of the user device. At 3140, the preference service 325 may store the location data at the local storage 330. The local storage 330 may save a geocode address manually input by the user, coordinates automatically determined by the geolocation service 315 (e.g., at 365), or both. At 3145, the local storage 330 may confirm, to the preference service 325, that the location data has been stored. For instance, the local storage 330 may indicate to the preference service 325 that the location data has been successfully stored.

At 3150, the preference service 325 may indicate to the UI layer 305 that location setup is complete. In some examples, the UI layer 305 may display the indication that the location setup is complete for view by the user. In some cases, the system may proceed to a user preference establishment procedure based on the completion of the location setup. In some aspects, the system may apply the stored location data to subsequent store calculations, such as those performed by the cost service 2215 as described with reference to FIG. 2.

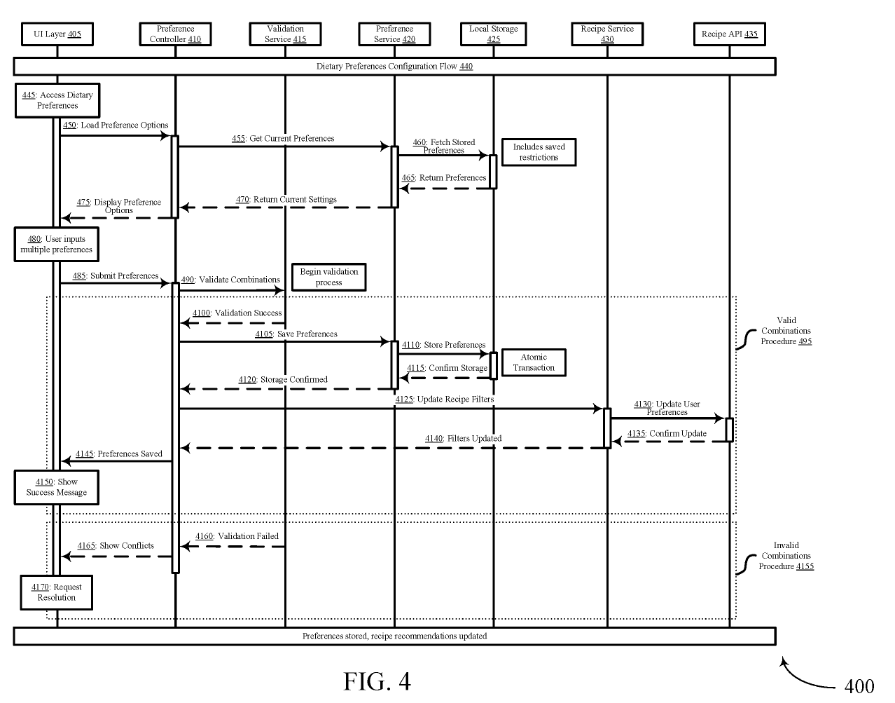

FIG. 4 shows an example of a flowchart 400 that supports an interactive grocery store platform in accordance with one or more aspects of the present disclosure. In some examples, the flowchart 400 may implement, or be implemented by, aspects of the system 100, the flowchart 200, and the flowchart 300. Operations of the flowchart 400 may be performed by a system including a UI layer 405, a preference controller 410, a validation service 415, a preference service 420, a local storage 425, a recipe service 430, and a recipe API 435. In some instances, aspects of the flowchart 400 may be implemented by a content platform 125 as described with reference to FIG. 1. For example, the content platform 125 may include or otherwise support a UI layer 405, a preference controller 410, a validation service 415, a preference service 420, a local storage 425, a recipe service 430, and a recipe API 435.

In the following description of the flowchart 400, the operations between the UI layer 405, the preference controller 410, the validation service 415, the preference service 420, the local storage 425, the recipe service 430, and the recipe API 435 may occur in a different order than the example order shown and, in some examples, may be performed by one or more different components other than those shown as examples. Some operations also may be omitted from the flowchart 400, and other operations may be added to the flowchart 400. Further, although some operations may be shown to occur at different times for discussion purposes, these operations may actually occur at the same time.

The UI layer 405, the preference controller 410, the validation service 415, the preference service 420, the local storage 425, the recipe service 430, and the recipe API 435 may perform operations of a dietary preferences configuration flow 440 to configure one or more user dietary preferences. The user dietary preferences may include allergies, dietary restrictions (e.g., including cultural and religious restrictions), liked ingredients, disliked ingredients, preferred cuisines, environmental preferences (e.g., organic ingredients, local sourcing, etc.), or any other user dietary preferences.

At 445, a user may access a dietary preferences screen or settings of an app (e.g., the mobile application 2180 as described with reference to FIG. 2) via the UI layer 405. At 450, the UI layer 405 may prompt the preference controller 410 to load one or more preference options. For instance, the one or more preference options may include one or more stored user dietary preferences or one or more preference settings or options. At 455, the preference controller 410 may request current preferences for the user from the preference service 420. At 460, the preference service 420 may fetch stored preferences for the user (e.g., including saved dietary restrictions) from the local storage 425. At 465, the local storage 425 may output (e.g., return) the stored preferences (e.g., which may be the current preferences for the user) to the preference service 420. At 470, the preference service 420 may output, to the preference controller 410, one or more current settings associated with the current preferences.

At 475, the preference controller 410 may output the one or more preference options to the UI layer 405, and the UI layer 405 may display the one or more preference options. In some aspects, the preference options may include preference categories (e.g., allergies, dietary restrictions, etc.) and current settings for the preference categories. At 480, the user may input multiple preferences via the UI layer 405. For example, the user may select dietary restrictions, allergens, preferred cuisines, or other dietary preferences. Additionally, or alternatively, the user may input one or more custom restrictions.

At 485, the UI layer 405 may submit the multiple preferences input by the user to the preference controller 410. In some aspects, the system may process the multiple preferences in accordance with a restriction processing protocol. For example, the restriction processing protocol may include structured data capture for dietary constraints, classification of allergen severity, handling of cultural and religious restrictions, differentiation between optional preferences and requirements, or any combination thereof.

At 490, the preference controller 410 may prompt the validation service 415 to attempt to validate one or more combinations of the multiple preferences input by the user. For instance, the validation service 415 may determine whether the one or more combinations are compatible and lack contradictions between the multiple preferences (e.g., an ingredient preference for cheese may be incompatible with dairy as a selected allergen). In some aspects, the validation service 415 may implement incompatibility detection algorithms, priority-based resolution rules, preference strength weighting, or any combination thereof to perform preference conflict resolution. Additionally, or alternatively, the validation service 415 may solicit user confirmation to resolve preference conflict in accordance with an invalid combinations procedure 4155. The system may implement a valid combination procedure 495 or the invalid combinations procedure 4155 based on whether the validation service 415 successfully validates the one or more combinations of the multiple preferences.

If the validation service 415 successfully validates the one or more combinations, the system may implement the valid combination procedure 495. At 4100, the validation service 415 may send an indication of validation success to the preference controller 410. At 4105, the preference controller 410 may send the multiple preferences to the preference service 420, and the preference service 420 may save the multiple preferences. At 4110, the preference service 420 may store the multiple preferences at the local storage 425. In some aspects, the local storage 425 may store the multiple preferences as an atomic transaction. At 4115, the local storage 425 may indicate confirmation of storage of the multiple preferences to the preference service 420. At 4120, the preference service 420 may indicate to the preference controller 410 that storage of the multiple preferences has been confirmed.

At 4125, the preference controller 410 may prompt the recipe service 430 to update one or more recipe filters based on the multiple preferences. For instance, the recipe service 430 may be an example of the recipe service 2210 as described with reference to FIG. 2, and the recipe service 430 may select one or more candidate recipes in accordance with the one or more recipe filters. At 4130, the recipe service 430 may prompt the recipe API 435 to update one or more user preferences in accordance with the one or more recipe filters. That is, the recipe service 430 may synchronize with the recipe API 435. At 4135, the recipe API 435 may confirm, to the recipe service 430, that the one or more user preferences have been updated. At 4140, the recipe service 430 may indicate to the preference controller 410 that the one or more recipe filters have been successfully updated.

At 4145, the preference controller 410 may indicate to the UI layer 405 that the multiple user preferences have been saved. At 4150, the UI layer 405 may display a success message for view by the user indicating that the multiple user preferences have been saved.

If the validation service 415 is unsuccessful in validating the one or more combinations, the system may implement the invalid combinations procedure 4155. At 4160, the validation service 415 may indicate to the preference controller 410 that validation of the one or more combinations failed. At 4165, the preference controller 410 may prompt the UI layer 405 to display (e.g., show) one or more conflicts associated with the unsuccessful validation of the one or more combinations. For instance, the one or more conflicts may be combinations of user preferences that are incompatible or contradictory. At 4170, the UI layer 405 may display a request that the user perform resolution of the one or more conflicts. For instance, the UI may display combinations of user preferences that are associated with conflicts so that the user may determine which preferences should be implemented or prioritized. If the user successfully resolves the one or more conflicts, the system may follow the valid combination procedure 495.

In some aspects, the system (e.g., a dietary preferences engine of the system) may dynamically adapt the user preferences beyond the multiple preferences directly input by the user at 480. In some cases, the system may perform implicit preference extraction, for example based on suggested recipes selected or unselected by the user. Additionally, or alternatively, the system may perform feedback-based refinement, temporary override management, or both. In some examples, the system may implement special occasion handling. For instance, the system may account for religious holidays during which user preferences may change, or the system may determine that a user prefers certain recipes or cuisines on certain holidays.

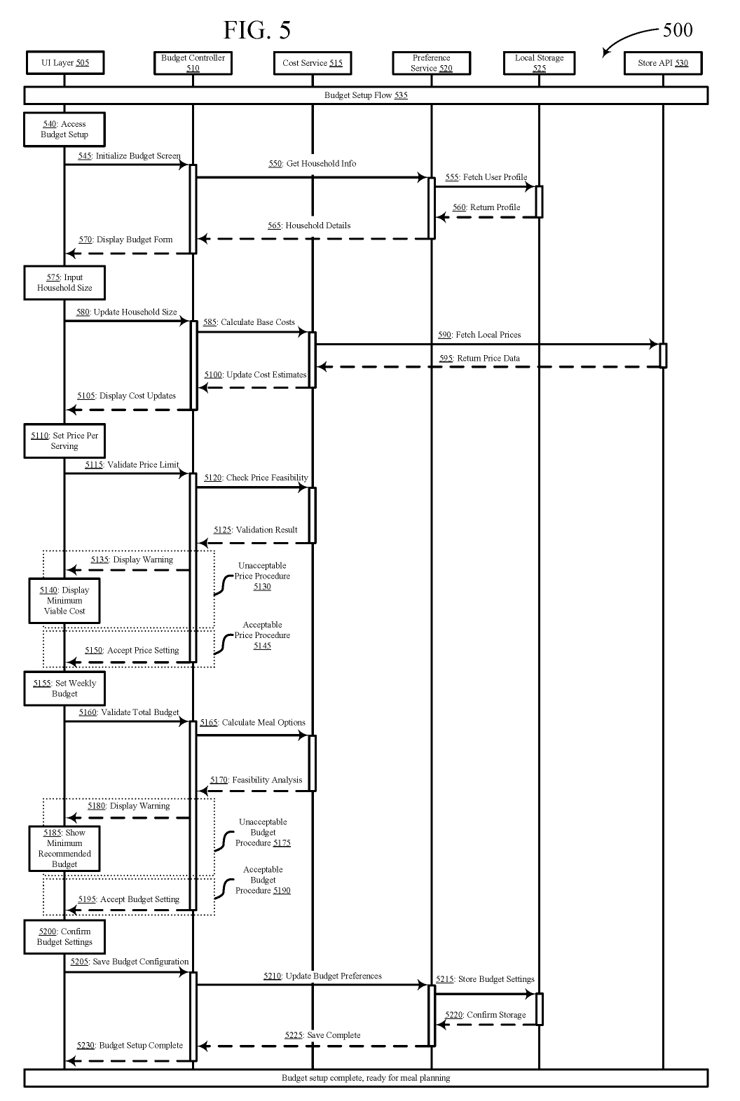

FIG. 5 shows an example of a flowchart 500 that supports an interactive grocery store platform in accordance with one or more aspects of the present disclosure. In some examples, the flowchart 500 may implement, or be implemented by, aspects of the system 100, the flowchart 200, the flowchart 300, and the flowchart 400. Operations of the flowchart 500 may be performed by a system including a UI layer 505, a budget controller 510, a cost service 515, a preference service 520, a local storage 525, and a store API 530. In some instances, aspects of the flowchart 500 may be implemented by a content platform 125 as described with reference to FIG. 1. For example, the content platform 125 may include or otherwise support a UI layer 505, a budget controller 510, a cost service 515, a preference service 520, a local storage 525, and a store API 530.

In the following description of the flowchart 500, the operations between the UI layer 505, the budget controller 510, the cost service 515, the preference service 520, the local storage 525, and the store API 530 may occur in a different order than the example order shown and, in some examples, may be performed by one or more different components other than those shown as examples. Some operations also may be omitted from the flowchart 500, and other operations may be added to the flowchart 500. Further, although some operations may be shown to occur at different times for discussion purposes, these operations may actually occur at the same time.

The UI layer 505, the budget controller 510, the cost service 515, the preference service 520, the local storage 525, and the store API 530 may perform operations of a budget setup flow 535 to configure a user budget.

At 540, a user may access a budget setup screen or settings of an app (e.g., the mobile application 2180 as described with reference to FIG. 2) via the UI layer 505. At 545, the UI layer may prompt the budget controller 510 to initialize the budget setup screen (e.g., initialize existing household information). At 550, the budget controller 510 may fetch household information (e.g., a household size, a household budget) from the preference service 520. At 555, the preference service 520 may fetch a user profile including the household information from the local storage 525. At 560, the local storage 525 may output the user profile to the preference service 520. At 565, the preference service 520 may output the household information (e.g., household details) to the budget controller 510. At 570, the budget controller 510 may output the household information to the UI layer 505, and the UI layer 505 may display a budget form including the household information. To illustrate, the budget form may include one or more budget-related categories (e.g., household size, household budget), and the budget form may show existing user settings for the one or more budget-related categories based on the retrieved household information.

At 575, the user may input a household size via the UI layer 505. For instance, the user may change a household size setting via the budget setup screen. At 580, the UI layer 505 may forward the input household size to the budget controller 510 in order to update a household size associated with the user. At 585, the budget controller 510 may prompt the cost service 515 to calculate base costs for the household based on the input (e.g., updated) household size. At 590, the budget controller 510 may fetch local prices from the store API 530. For example, the local prices may be prices of ingredients at stores within a threshold radius of a user location, such as a location configured via an initial location setup flow as illustrated in FIG. 3. At 595, the store API 530 may output price data associated with the local prices to the cost service 515. At 5100, the cost service 515 may update cost estimates (e.g., base costs) for the user based on the price data and the input household size, and the cost service 515 may output the updated cost estimates to the budget controller 510. At 5105, the budget controller may output the updated cost estimates to the UI layer 505, and the UI layer 505 may display the updates cost estimates.

At 5110, the user may input a price per serving via the UI layer 505. For instance, the user may input the price per serving via the budget setup screen. At 5115, the UI layer 505 may send the input price per serving to the budget controller 510 and prompt the budget controller 510 to validate the price per serving (e.g., a price limit). At 5120, the budget controller 510 may send the input price per serving to the cost service 515 and prompt the cost service 515 to check a feasibility of the input price per serving. At 5125, the cost service 515 may perform validation of the input price per serving and output the validation results to the budget controller 510. The system may implement an unacceptable price procedure 5130 or an acceptable price procedure 5145 based on whether the cost service 515 determines the input price per serving to be valid or invalid.

If the cost service 515 determines that the input price per serving is invalid, the system may implement the unacceptable price procedure 5130. At 5135, the budget controller 510 may prompt the UI layer 505 to display a warning to the user indicating that the price per serving is unacceptable (e.g., higher than a threshold cost). At 5140, the UI layer 505 may display a threshold (e.g., minimum) viable cost to the user. In some implementations, the user may input a new price per serving (e.g., based on the threshold viable cost), and the system may return to the setting a price per serving step (e.g., at 5110) of the flowchart 500.

If the cost service 515 determines that the input price per serving is valid, the system may implement the acceptable price procedure 5145. At 5150, the budget controller 510 may indicate to the UI layer 505 that the input price per serving (e.g., a price setting) is acceptable. In some aspects, the UI layer 505 may display (e.g., for view by the user) an updated budget setup screen indicating the updated price per serving (e.g., input by the user at 5110).

At 5155, the user may set a weekly budget via the UI layer 505. For instance, the user may set a weekly budget indicating a sum of weekly meal costs for members of a household having the household size input at 575. At 5160, the UI layer 505 may prompt the budget controller 510 to validate the weekly budget (e.g., a total budget for the household). At 5165, the budget controller 510 may prompt the cost service 515 to calculate meal options for the user based on the weekly budget. At 5170, the cost service 515 may output (e.g., return) a feasibility analysis to the budget controller 510 based on the calculated meal options and the weekly budget. For instance, the cost service 515 may determine whether sufficient meals for the household size can be purchased based on the weekly budget. In some aspects, the cost service 515 may perform the feasibility analysis based on the local prices fetched at 590. The system may implement an unacceptable budget procedure 5175 or an acceptable budget procedure 5190 based on the feasibility analysis.

If the cost service 515 determines the weekly budget to be infeasible, the system may implement the unacceptable budget procedure 5175. At 5180, the budget controller 510 may prompt the UI layer 505 to display a warning indicating that the weekly budget is infeasible. At 5185, the UI layer 505 may display a threshold (e.g., minimum) recommended budget to the user. In some implementations, the user may input a new weekly budget (e.g., based on the threshold recommended budget), and the system may return to the setting a weekly budget step (e.g., at 5155) of the flowchart 500.

If the cost service 515 determines that the weekly budget is feasible, the system may implement the acceptable budget procedure 5190. At 5195, the budget controller 510 may indicate to the UI layer 505 that the input weekly budget is acceptable. In some aspects, the UI layer 505 may display to the user an updated budget setup screen indicating the updated weekly budget (e.g., input by the user at 5155).

At 5200, the user may confirm the updated budget settings (e.g., the household size, the price per serving, the weekly budget) via the UI layer 505. For instance, the UI layer 505 may display an updated budget screen indicating the updated budget settings, and the user may select a button confirming that the updated budget settings are accurate or desired by the user. At 5205, the UI layer 505 may prompt the budget controller 510 to save a budget configuration associated with the updated budget settings. At 5210, the budget controller 510 may prompt the preference service 520 to update budget preferences stored for the user. At 5215, the preference service 520 may store the updated budget preferences at the local storage 525. At 5220, the local storage 525 may confirm to the preference service 520 that the updated budget preferences are stored. At 5225, the preference service 520 may indicate a completion of saving the updated budget preferences to the budget controller 510. At 5230, the budget controller 510 may indicate a completion of the budget setup process to the UI layer 505. In some cases, the UI layer 505 may display, for view by the user, an indication that the budget setup process is complete.

In some cases, the system may proceed to a meal planning procedure based on the completion of the budget setup. In some aspects, the system may apply the stored budget settings to subsequent meal recommendations, such as generated via the AI meal generation flow 205 as described with reference to FIG. 2. In some examples, the budget setup flow 535 may support functions of a cost optimization engine, which may perform recipe cost estimation, generate ingredient substitution suggestions, make seasonal adjustment recommendations, identify bulk purchase opportunities, or any combination thereof. In some cases, the budget setup flow 535 may support household economic profiling operations, a budget constraint processor, or both. For instance, the house economic profiling operations may include household size tracking, per-person calculation algorithms, regional cost-of-living adjustments, economic bracket categorization, or any combination thereof. The budget constraint processor may perform validation of a threshold (e.g., maximum) price per serving, calculate one or more weekly budgets, perform special occasion override handling, assess budget feasibility, or any combination thereof. In some aspects, a budget configuration system may perform operations of the flowchart 500, and the cost optimization engine, the budget constraint processor, and the household economic profiling operations may be implemented by the budget configuration system.

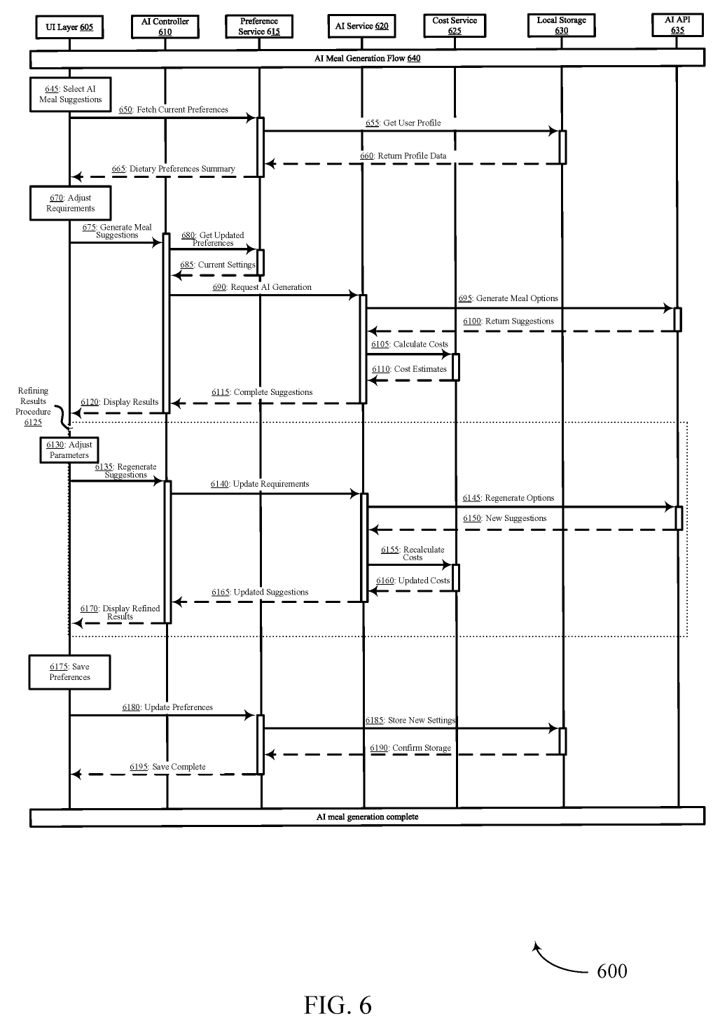

FIG. 6 shows an example of a flowchart 600 that supports an interactive grocery store platform in accordance with one or more aspects of the present disclosure. In some examples, the flowchart 600 may implement, or be implemented by, aspects of the system 100, the flowchart 200, the flowchart 300, the flowchart 400, and the flowchart 500. Operations of the flowchart 600 may be performed by a system including a UI layer 605, an AI controller 610, a preference service 615, an AI service 620, a cost service 625, a local storage 630, and an AI API 635.

In some instances, aspects of the flowchart 600 may be implemented by a content platform 125 as described with reference to FIG. 1. For example, the AI controller 610, the AI service 620, the AI API 635, or any combination thereof may be examples of, or may perform the similar features as the AI component 145. Additionally or alternatively, the content platform 125 may include or otherwise support a UI layer 605, a preference service 615, a cost service 625, and a local storage 630.

In the following description of the flowchart 600, the operations between the UI layer 605, the AI controller 610, the preference service 615, the AI service 620, the cost service 625, the local storage 630, and the AI API 635 may occur in a different order than the example order shown and, in some examples, may be performed by one or more different components other than those shown as examples. Some operations also may be omitted from the flowchart 600, and other operations may be added to the flowchart 600. Further, although some operations may be shown to occur at different times for discussion purposes, these operations may actually occur at the same time.

The UI layer 605, the AI controller 610, the preference service 615, the AI service 620, the cost service 625, the local storage 630, and the AI API 635 may perform operations of an AI meal generation flow 640 to generate one or more AI meal suggestions.

At 645, a user may select, via the UI layer 605, an option associated with generating AI meal suggestions. For example, the UI layer 605 may display a button for generating AI meal suggestions, and the user may select the button to request AI meal suggestions. At 650, the UI layer 605 may request the preference service 615 to fetch current preferences associated with the user. For example, the current preferences may include allergens, liked ingredients, disliked ingredients, user dietary preferences and restrictions, a user budget, a user location, or any other user preferences. At 655, the preference service 615 may obtain a user profile including the current preferences from the local storage 630. At 660, the local storage 630 may return profile data associated with the user profile to the preference service 615. At 665, the preference service 615 may output a dietary preferences summary including the user profile and associated current preferences to the UI layer 605, and the UI layer 605 may display the dietary preferences summary.

At 670, a user may select an option to adjust one or more requirements for AI meal suggestion via the UI layer 605. For example, the user may adjust one or more user preferences based on the dietary preferences summary displayed by the UI layer 605. To illustrate, the UI layer 605 may display a dietary preferences screen or settings indicating the current preferences, and the user may change these preferences via the UI layer 605. In some aspects, the system may update the one or more user preferences via a dietary preferences configuration flow as described with reference to FIG. 4.

At 675, the UI layer 605 may prompt the AI controller 610 to generate one or more AI meal suggestions. At 680, the AI controller 610 may obtain one or more updated user preferences from the preference service 615. For instance, the one or more updated user preferences may be based on the user selecting the option to adjust one or more requirements at 670. At 685, the preference service 615 may return one or more current settings indicative of the one or more updated user preferences to the AI controller 610. At 690, the AI controller 610 may request for the AI service 620 to perform AI generation to generate the one or more AI meal suggestions. At 695, the AI service 620 may prompt the AI API 635 to generate one or more meal options (e.g., the one or more AI meal suggestions). In some aspects, the AI API 635 may provide access to one or more ML models for AI meal generation, a recipe database including recipes for suggestion or modification via the one or more ML models, or a combination thereof. At 6100, the AI API 635 may return one or more AI meal suggestions to the AI service 620.

At 6105, the AI service 620 may indicate for the cost service 625 to calculate costs associated with the one or more AI meal suggestions. For instance, the cost service 625 may calculate the costs based on pricing information associated with local grocery stores (e.g., within a threshold radius of a user location, for example a user location established via an initial location setup flow 340 as described with reference to FIG. 3). At 6110, the cost service 625 may output one or more cost estimates associated with the one or more AI meal suggestions to the AI service 620.

At 6115, the AI service 620 may output one or more complete suggestions including the one or more AI meal suggestions and the associated one or more cost estimates to the AI controller 610. At 6120, the AI controller 610 may output the one or more complete suggestions to the UI layer 605 and prompt the UI layer 605 to display the one or more complete suggestions (e.g., results of the AI meal generation). For instance, the UI layer may display a list of the one or more complete suggestions for view by the user.

In some implementations, the system may implement a refining results procedure 6125 to refine the AI meal suggestions provided to the user at 6120. In some aspects, the system may repeat the refining results procedure 6125 so that the user may iteratively refine AI meal generation results. At 6130, the user may adjust one or more parameters used for the AI meal generation via the UI layer 605. In some examples, the user may adjust one or more user preferences to refine the AI meal generation results. For instance, the user may make one or more temporary preference changes. The temporary preference changes may be session-only preferences (e.g., the temporary preference changes may be unassociated with changes to user preferences stored at the local storage 630 and managed by the preference service 615), or the user may save the temporary preference changes (e.g., immediately or at 6175 of the AI meal generation flow 640). In some examples, the user may adjust one or more parameters multiple times to repeat the refining results procedure 6125 to support iterative refinement of the AI meal generation results.

At 6135, the UI layer 605 may prompt the AI controller 610 to regenerate the one or more AI meal suggestions based on the adjusted parameters. At 6140, the AI controller 610 may indicate one or more updated requirements (e.g., the adjusted parameters) for AI meal generation to the AI service 620. At 6145, the AI service 620 may prompt the AI API 635 to regenerate one or more AI meal suggestions. For instance, the AI API 635 may provide access the one or more ML models and provide the one or more ML models with the one or more updated requirements so that the one or more ML models may regenerate the one or more AI meal suggestions. At 6150, the AI API 635 may provide one or more new (e.g., regenerated based on the adjusted parameters) meal suggestions to the AI service 620.

At 6155, the AI service 620 may prompt the cost service 625 to calculate one or more updated costs associated with the one or more new meal suggestions. At 6160, the cost service 625 may output the one or more updated costs to the AI service 620.

At 6165, the AI service 620 may provide one or more updated suggestions including the one or more new meal suggestions and the associated one or more updated costs to the AI controller 610. At 6170, the AI controller 610 may output the one or more updated suggestions (e.g., refined results of the AI meal generation process) to the UI layer 605 and prompt the UI layer 605 to display the one or more updated suggestions. For instance, the UI layer 605 may display a list of the one or more updated suggestions for view by the user.

At 6175, the user may, in some examples, select an option to save one or more preferences via the UI layer 605. For instance, the one or more preferences may be the adjusted parameters input at 6130. To illustrate, the user may determine that the one or more updated suggestions are satisfactory and accordingly determine that the one or more preferences are associated with desirable AI meal generation results (e.g., satisfactory suggested meals). At 6180, the UI layer 605 may indicate for the preference service 615 to update one or more stored user preferences. At 6185, the preference service 615 may store the one or more user preferences (e.g., new user settings) at the local storage 630. At 6190, the local storage 630 may indicate confirmation of storage of the one or more user preferences to the preference service 615. At 6195, the preference service 615 may indicate to the UI layer 605 that saving (e.g., storage) of the one or more user preferences is complete.

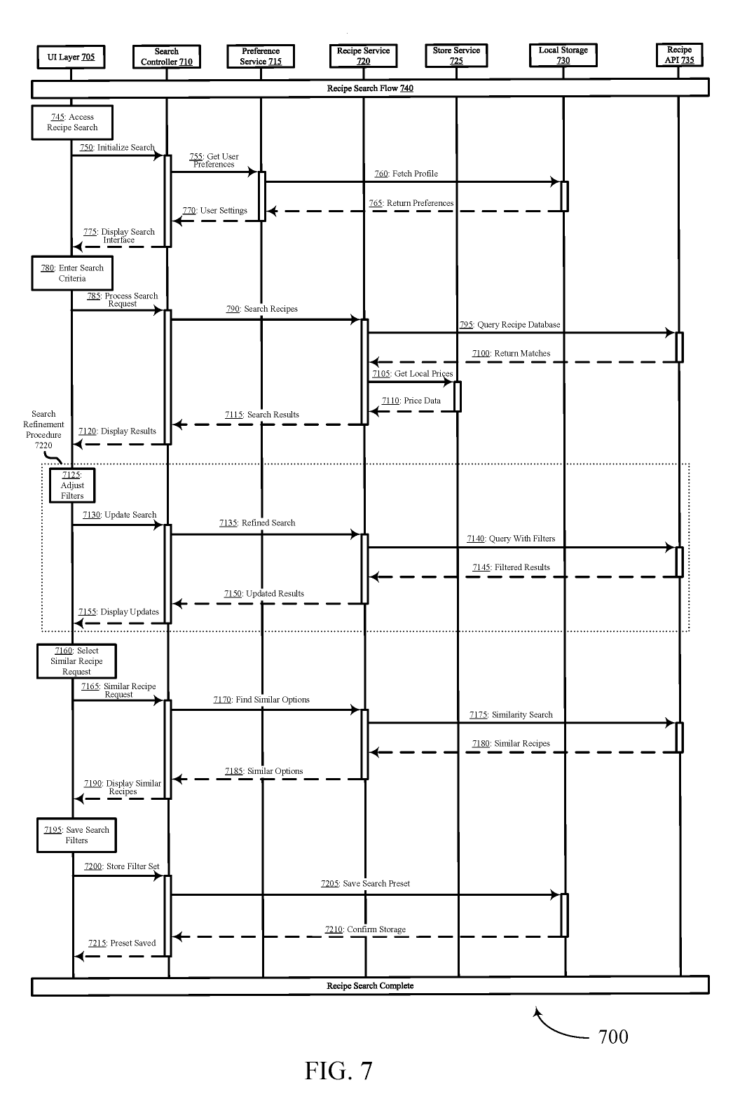

FIG. 7 shows an example of a flowchart 700 that supports an interactive grocery store platform in accordance with one or more aspects of the present disclosure. In some examples, the flowchart 700 may implement, or be implemented by, aspects of the system 100, the flowchart 200, the flowchart 300, the flowchart 400, the flowchart 500, and the flowchart 600. Operations of the flowchart 700 may be performed by a system including a UI layer 705, a search controller 710, a preference service 715, a recipe service 720, a store service 725, a local storage 730, and a recipe API 735. In some instances, aspects of the flowchart 700 may be implemented by a content platform 125 as described with reference to FIG. 1. For example, the content platform 125 may include or otherwise support a UI layer 705, a search controller 710, a preference service 715, a recipe service 720, a store service 725, a local storage 730, and a recipe API 735.

In the following description of the flowchart 700, the operations between the UI layer 705, the search controller 710, the preference service 715, the recipe service 720, the store service 725, the local storage 730, and the recipe API 735 may occur in a different order than the example order shown and, in some examples, may be performed by one or more different components other than those shown as examples. Some operations also may be omitted from the flowchart 700, and other operations may be added to the flowchart 700. Further, although some operations may be shown to occur at different times for discussion purposes, these operations may actually occur at the same time.

The UI layer 705, the search controller 710, the preference service 715, the recipe service 720, the store service 725, the local storage 730, and the recipe API 735 may perform operations of a recipe search flow 740 to provide one or more recipes to a user based on a user search request.

At 745, the user may select an option to access, via the UI layer 705, a recipe search function or screen of a mobile application (e.g., the mobile application 2180 as described with reference to FIG. 2) associated with the system. At 750, the UI layer 705 may indicate for the search controller 710 to initialize a recipe search based on the user selecting the option to access the recipe search function or screen. At 755, the search controller 710 may obtain one or more user preferences (e.g., or settings) from the preference service 715. For instance, the one or more user preferences may include user dietary restrictions and preferences, liked ingredients, disliked ingredients, preferred cuisines, allergens, a user budget, a user location, a user cooking skill level, or any other user preferences. At 760, the preference service 715 may fetch a user profile including the one or more user preferences from the local storage 730. At 765, the local storage 730 may return the one or more user preferences to the preference service 715. At 770, the preference service 715 may return the one or more user preferences (e.g., user settings) to the search controller 710. At 775, the search controller 710 may output the one or more user preferences to the UI layer 705 and prompt the UI layer 705 to display a search interface. For instance, the UI layer 705 may display a recipe search screen, which may include a search bar, one or more filter options (e.g., cuisines, recipe preparation times, cooking skill levels, etc.), or other searching functionalities.

At 780, the user may enter (e.g., input) one or more search criteria via the UI layer 705. For instance, the user may input a text prompt into a search bar, select one or more filter options, or both via a recipe search screen. At 785, the UI layer 705 may prompt the search controller 710 to process a search request associated with the one or more search criteria entered by the user at 780. At 790, the search controller 710 may prompt the recipe service 720 to search for one or more recipes that meet the one or more search criteria. At 795, the recipe service 720 may query a recipe database associated with the recipe API 735. For instance, the query may include a request for the one or more recipes that meet the one or more search criteria. At 7100, the recipe API 735 may return (e.g., to the recipe service 720) one or more recipes that match the one or more search criteria. At 7105, the recipe service 720 may prompt the store service 725 to determine local prices associated with ingredients of the one or more recipes. For instance, the store service 725 may obtain prices for the ingredients at one or more stores within a threshold radius of a user location, for example a user location established through an initial location setup flow as described with reference to FIG. 3. At 7110, the store service 725 may return price data associated with the one or more recipes (e.g., or the ingredients of the one or more recipes) to the recipe service 720. At 7115, the recipe service 720 may output (e.g., return) search results (e.g., including the one or more recipes that match the one or more search criteria and the price data) to the search controller 710. At 7120, the search controller 710 may output the search results to the UI layer 705 and prompt the UI layer 705 to display the search results. For instance, the UI layer 705 may display a list of the search results for view by the user.

In some examples, the system may implement a search refinement procedure 7220 to refine the search results based on user input. At 7125, the user may adjust one or more filters (e.g., search criteria) via the UI layer 705. For example, the user may select or deselect one or more filters via a recipe search screen, such as cuisine filters, cooking skill filters, recipe preparation time filters, or other recipe filters. At 7130, the UI layer 705 may prompt the search controller 710 to process an updated search request based on the adjustment of the one or more filters at 7125. At 7135, the search controller 710 may prompt the recipe service 720 to search for one or more recipes that satisfy the one or more adjusted filters. That is, the search controller 710 may prompt the recipe service 720 to perform a refined recipe search based on the one or more adjusted filters. At 7140, the recipe service 720 may query the recipe database associated with the recipe API 735. For example, the query may include a request for one or more recipes that satisfy the one or more adjusted filters. In some aspects, the one or more recipes may satisfy one or more of the initial search criteria entered at 780 in addition to the one or more adjusted filters. At 7145, the recipe API 735 may return the one or more recipes that satisfy the one or more adjusted filters to the recipe service 720. At 7150, the recipe service 720 may return the one or more recipes that satisfy the one or more adjusted filters to the search controller 710. That is, the recipe service 720 may return one or more updated recipe search results to the search controller 710. At 7155, the search controller 710 may output the one or more updated recipe search results to the UI layer 705 and prompt the UI layer 705 to display the one or more updated recipe search results.

At 7160, the user may select an option for a similar recipe request via the UI layer 705 to search for recipes similar to a first recipe. For instance, the user may select a “More Like This” button associated with a first recipe to search for recipes similar to the first recipe. In some aspects, the first recipe may be a recipe displayed via the UI at 7120 or 7155 based on the initial recipe search results or the updated recipe search results. At 7165, the UI layer 705 may output the similar recipe request to the search controller 710. At 7170, the search controller 710 may prompt the recipe service 720 to find similar recipes (e.g., similar options) to the first recipe. At 7175, the recipe service 720 may query the recipe database associated with the recipe API 735 to perform a similarity search. For instance, the recipe API 735 may support searching the recipe database for recipes that satisfy one or more similarity criteria in comparison to the first recipe. At 7180, the recipe API 735 may output one or more similar recipes to the recipe service 720. At 7185, the recipe service 720 may output the one or more similar recipes (e.g., similar options) to the search controller 710. At 7190, the search controller 710 may output the one or more similar recipes to the UI layer 705 and prompt the UI layer 705 to display the one or more similar recipes.

At 7195, the user may, in some examples, select an option to save one or more search filters (e.g., based on the initial search criteria entered at 780 or the adjusted filters entered at 7125) via the UI layer 705. For instance, the user may determine that one or more search results (e.g., the initial recipe search results displayed at 7120 or the updated recipe search results displayed at 7155) are satisfactory and decide to save the one or more search filters associated with the one or more search results. At 7200, the UI layer 705 may prompt the search controller 710 to store a filter set including the one or more search filters. At 7205, the search controller 710 may save a search preset (e.g., the filter set) at the local storage 730. At 7210, the local storage 730 may output, to the search controller 710, a confirmation of storage of the search preset. At 7215, the search controller 710 may indicate to the UI layer 705 that the search preset has been saved. In some cases, the UI layer 705 may display an indication that the search preset has been saved for view by the user.

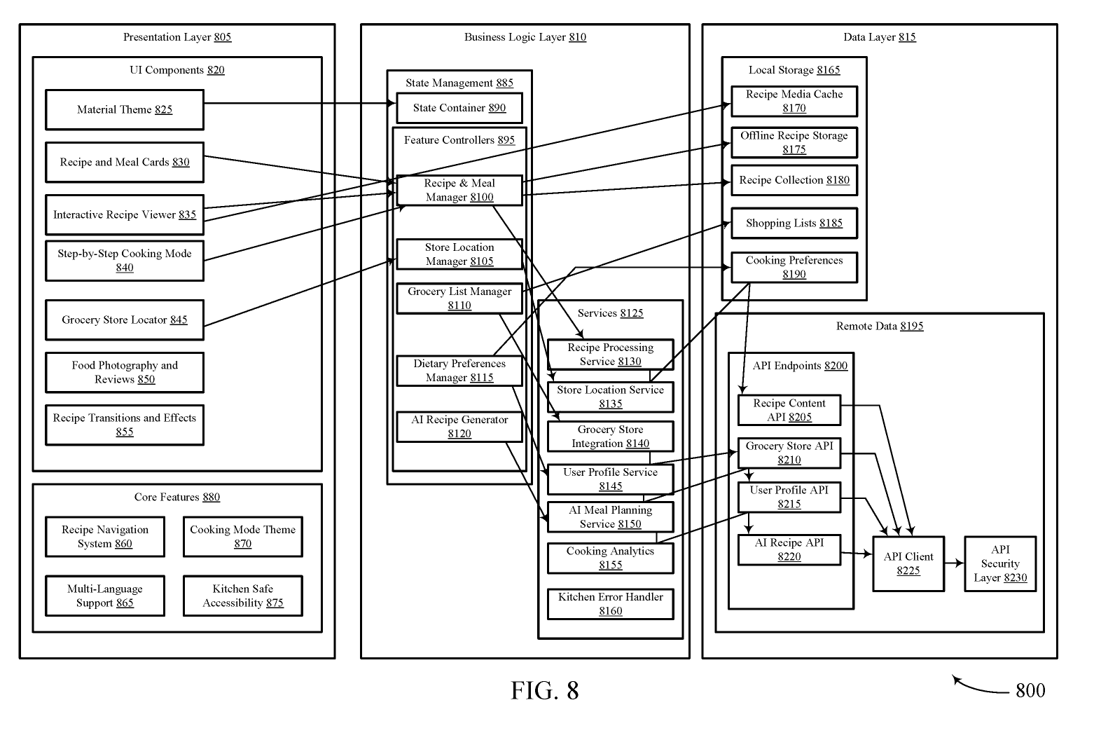

FIG. 8 shows an example of a mobile application 800 that supports an interactive grocery store platform in accordance with one or more aspects of the present disclosure. In some examples, the mobile application 800 may implement, or be implemented by, aspects of the system 100, the flowchart 200, the flowchart 300, the flowchart 400, the flowchart 500, the flowchart 600, and the flowchart 700. The mobile application 800 may include a presentation layer 805, a business logic layer 810, and a data layer 815. In some instances, aspects of the mobile application 800 may be implemented by a content platform 125 as described with reference to FIG. 1. For example, the mobile application 800 may be an example of an application installed and running on any of a server (e.g., cloud client 105-a), a smartphone (e.g., cloud client 105-b), a laptop (e.g., cloud client 105-c), or any suitable electronic device.

The presentation layer 805 may include one or more UI components 820 that support a layout and functionality of the mobile application 800 via UIs. For examples, the UIs may be UIs of user devices that use (e.g., have downloaded) the mobile application 800. The UI components 820 may include a material theme 825, which may support a design and layout of material-based UI components of the mobile application 800 that are displayed via UIs. The UI components 820 may include recipe and meal cards 830 for displaying recipes (e.g., suggested recipes generated via an AI meal generation flow 205 as described with reference to FIG. 2 or recipes provided by a recipe search flow 740 as described with reference to FIG. 7). For example, the recipe and meal cards 830 may show recipe ingredients, recipe steps, recipe reviews, pictures of a recipe or meal, or any other information associated with a recipe or meal. The UI components 820 may include interactive recipe components such as an interactive recipe viewer 835 that allows a user to select and interact with recipes, for example zooming in on recipes, scrolling through portions of a recipe, or selecting recipe and meal cards 830 for viewing. In some cases, the UI components 820 may include recipe transitions and effects 855, which may include design elements associated with the user transitioning between and viewing different recipe and meal cards 830.

In some implementations, the UI components 820 may include a cooking mode interface. The cooking mode interface may support one or more cooking modes, including a step-by-step cooking mode 840, which may support display of individual steps of a recipe in a tutorial-like manner. For example, the step-by-step cooking mode 840 may support display of a first recipe step at a UI, and the UI may display each subsequent recipe step after a user indicates that the user has completed a previous recipe step in accordance with the step-by-step cooking mode 840. In some examples, the step-by-step cooking mode 840 may support a recipe preparation process including steps such as a user entering the step-by-step cooking mode 840, a cooking controller retrieving recipe details, a voice service initializing hands-free control, a user progressing through recipe steps using touch or voice, a timer controller managing one or more cooking timers, the mobile application 800 automatic saving user progress (e.g., if a user interrupted during completion of the recipe), the user completing the recipe, the mobile application 800 recording user completion of the recipe in a cooking history of the user, or any combination thereof.

The UI components 820 may, in some cases, include a grocery store locator 845 for displaying stores near a user location (e.g., stores within a threshold radius of a user location established via an initial location setup flow 340 as described with reference to FIG. 3). In some aspects, the grocery store locator 845 may support store mapping and visualization. For instance, the grocery store locator 845 may support an interactive map showing the user location and nearby stores.

In some examples, the UI components 820 may include food photography and reviews 850. That is, the UI components 820 may support integration of food photography with the mobile application 800. For example, users may submit photos and reviews of recipes suggested to or accessed by the users via the mobile application 800, and other users may view these photos and reviews via UIs.

The presentation layer 805 may further include one or more core features 880. The one or more core features 880 may include a recipe navigation system 860, which may allow a user to navigate through recipes, such as suggested recipes generated via an AI meal generation flow 205 as described with reference to FIG. 2. For instance, the recipe navigation system 860 may support selection of recipes through searching, scrolling, and filtering functionalities. In some examples, the one or more core features 880 may include multi-language support 865, which may allow a user to view aspects of the mobile application 800, including recipes, in a desired language. The one or more core features 880 may include a cooking mode theme 870, which may support a layout and functionality of the mobile application 800 when a user uses a cooking mode of the mobile application 800. For example, the cooking mode theme 870 may support the step-by-step cooking mode 840 or other cooking modes. In some cases, the one or more core features 880 may include kitchen safe accessibility 875. The kitchen safe accessibility 875 may include screen reader optimization (e.g., facilitating user traversal through a recipe via a UI), kitchen environment adaptations (e.g., voice controls, audio narration of recipes), one-handed operations modes, attention-minimizing interactions, or any combination thereof.

The business logic layer 810 may include one or more state management components 885. A state container 890 may manage one or more states of the mobile application 800 based on user data and inputs via the UI. The one or more state management components 885 may further include one or more features controllers 895 for controlling functions of various features of the mobile application 800. The feature controllers 895 may include a recipe and meal manager 8100, which may manage interactions between a recipe processing service 8130, the recipe and meal cards 830, the interactive recipe viewer 835, the step-by-step cooking mode 840, an offline recipe storage 8175, and a recipe collection 8180. For example, the recipe and meal manager 8100 may be manage functions related to retrieving, searching, and displaying recipes. The feature controllers 895 may include a store location manager 8105 that manages interactions between a store location service 8135 and the grocery store locator 845, a grocery list manager that manages a grocery store integration functionality 8140 and one or more shopping lists 8185 stored for a user, a dietary preferences manager 8115 that manages one or more cooking preferences 8190 (e.g., dietary preferences, allergies, dietary restrictions, liked and disliked ingredients, etc.) and a user profile service 8145, or any combination thereof. The feature controllers 895 may, in some cases, include an AI recipe generator 8120 that controls an AI meal planning service 8150 for generation of suggested meals, for example via an AI meal generation flow 205 as illustrated in FIG. 2.

The business logic layer 810 may include one or more services 8125 that perform one or more functions of the mobile application 800. The services 8125 may include the recipe processing service 8130, which may interact with the store location service 8135 and one or more cooking preferences 8190 (e.g., preferences stored for a user) to obtain recipe content data via a recipe content API 8205. For instance, the recipe processing service 8130 may performs functions associated with processing of one or more recipes provided (e.g., or suggested) by the mobile application 800 by obtaining ingredient information, recipe step information, nutritional information, or other information about content of the one or more recipes. In some aspects, the recipe processing service 8130 may sort, filter, or obtain recipes in accordance with one or more cooking preferences 8190. The store location service 8135 may perform functions associated with determining grocery stores within a threshold radius of a user location, such as a user location established through an initial location setup flow 340 as described with reference to FIG. 3. The store location service 8135 may interact with the recipe processing service 8130 and the recipe content API 8205 to identify stores that sell ingredients associated with recipes obtained via the recipe content API 8205.

The services 8125 may include the grocery store integration functionality 8140 and a user profile service 8145, which may interact with a grocery store API 8210 to obtain data associated with grocery stores within a threshold radius of the user. For example, the user profile service 8145 may perform functions associated with establishing and monitoring user profile settings and preferences, which may include a user location. The grocery store API 8210 may obtain data associated with grocery stores (e.g., products sold, pricing information, store layout, etc.) that are within a threshold location of the user location, and the grocery store integration functionality 8140 may support integration of the grocery store data with the mobile application 800.

The services 8125 may, in some examples, include an AI meal planning service 8150, which may interact with the user profile service 8145, the grocery store API 8210, and a user profile API 8215, to provide AI meal suggestions, such as those generated via an AI meal generation flow 205 as described with reference to FIG. 2. The AI meal planning service 8150 may utilize user profile information provided by the user profile API 8215 and grocery store data provided by the grocery store API 8210 to generate one or more meal suggestions. For instance, the user profile information may include dietary restriction and preferences as well as budget information, which the AI meal planning service 8150 may use to dynamically adapt meal suggestions to a specific user. The grocery store data may allow the AI meal planning service 8150 to take into account ingredient pricing and availability when generating meal suggestions. In some examples, the AI meal planning service 8150 may interact with a cooking analytics service 8155, the user profile API 8215, and the AI recipe API 8220 to generate the one or more meal suggestions. For example, the AI recipe API 8220 may provide the AI meal planning service 8150 with access to one or more ML models for AI recipe generation, one or more recipe databases from which an ML model may select recipes (e.g., which may be adapted by one or more ML models), or a combination thereof. The cooking analytics service 8155 may provide analysis on a cooking process associated with a recipe, such as cooking time and difficulty level. In some cases, the AI meal planning service 8150 may use the analysis information, along with user profile information such as user cooking skill level and time availability provided by the user profile API 8215, to generate one or more meal suggestions.

In some examples, the services 8125 may include a kitchen error handler 8160, which may monitor and handle user errors during a cooking process. For instance, a user may access a recipe via the mobile application 800 and enter a cooking mode (e.g., the step-by-step cooking mode 840), and the kitchen error handler 8160 may monitor user progress through the recipe and resolve potential errors in the cooking process. In some aspects, the kitchen error handler 8160 may support cooking state recognition AI, which may include a computer vision and temporal modeling system for recognizing cooking progress, detecting potential errors, and providing context-appropriate guidance during recipe preparation.

The mobile application 800 may include a data layer 815, which may include one or more local storage components 8165. The one or more local storage components 8165 may include data (e.g., local or user-specific data) that is stored at a user device that has downloaded the mobile application 800. The one or more local storage components 8165 may include a recipe media cache 8170, which may temporarily store information associated with a recently viewed recipe. For instance, the interactive recipe viewer 835 may support viewing of a particular recipe, and the recipe media cache 8170 may temporarily store data associated with the particular recipe. The one or more local storage components 8165 may include an offline recipe storage 8175 that stores recipes for access when a user device is offline (e.g., lacks internet connection), a recipe collection 8180 that stores a collection of recipes for the user (e.g., recipes selected by or suggested to the user), or both. In some aspects, the recipe and meal manager 8100 may obtain recipe and meal information from the offline recipe storage 8175, the recipe collection 8180, or both.

In some cases, the one or more local storage components 8165 may include one or more shopping lists 8185, which may include ingredients for a meal plan or one or more recipes. The one or more shopping lists 8185 may, in some implementations, support store section organization (e.g., aisle-based grouping of ingredients, a store-specific layout adaptation, category-based classification, etc.). In some examples, the grocery list manager 8110 may obtain one or more grocery lists from the one or more shopping lists 8185 stored by the one or more local storage components 8165. In some examples, the one or more local storage components 8165 may include one or more cooking preferences 8190 associated with a user, such as user cooking skill level, user location, user dietary restrictions and preferences, user budget, or any other user preferences. In some aspects, the one or more cooking preferences 8190 may be accessed by the dietary preferences manager 8115.

The data layer 815 may include remote data 8195, which may be stored at remote servers, databases, or other storage locations. The remote data 8195 may include one or more API endpoints 8200. For example, the one or more API endpoints 8200 may be specific digital locations (e.g., URLs, URIs) that allow the mobile application 800 to access particular resources or functions with an API. The one or more API endpoints 8200 may include the recipe content API 8205, the grocery store API 8210, the user profile API 8215, and the AI recipe API 8220. The recipe content API 8205 may provide access to data associated with recipe content, such as ingredients, cooking materials, cooking steps, and nutritional information. The grocery store API 8210 may provide access to grocery store data, such as store location, product availability, and pricing information. The user profile API 8215 may provide access to user profile information, such as user preferences, settings, and location. The AI recipe API 8220 may provide access to one or more ML models for AI recipe generation, such as via an AI meal generation flow 205 as illustrated in FIG. 2. In some examples, the AI recipe API 8220 may provide access to one or more recipe databases storing recipes that may be selected or adapted by the one or more ML models.

The remote data 8195 may include an API client 8225, which may enable to mobile application 800 to interact with and request data from one or more APIs. For instance, the API client 8225 may manage client requests (e.g., via the mobile application 800) for data from the one or more APIs. The API endpoints 8200 may interact with the API client 8225 to obtain data from the one or more APIs.

The remote data 8195 may include an API security layer 8230, which may ensure security of the mobile application 800 and user data when accessing the one or more APIs. For instance, the API security layer 8230 may support transport layer security (TLS) protocol 1.3 for API communications, certificate pinning for the API endpoints 8200, payload encryption for sensitive data, or any other transit security measures. In some aspects, the API security layer 8230 may also support secure payment information handling, including compliance with Payment Card Industry (PCI) Data Security Standard (DSS) requirements, tokenization of payment details, refraining from persistently storing complete payment information, secure handoff to payment processors, or any combination thereof. For instance, a user may purchase ingredients for one or more recipes or one or more shopping lists 8185 via the mobile application 800, and the API security layer 8230 may ensure that financial transactions to purchase the ingredients are secure.

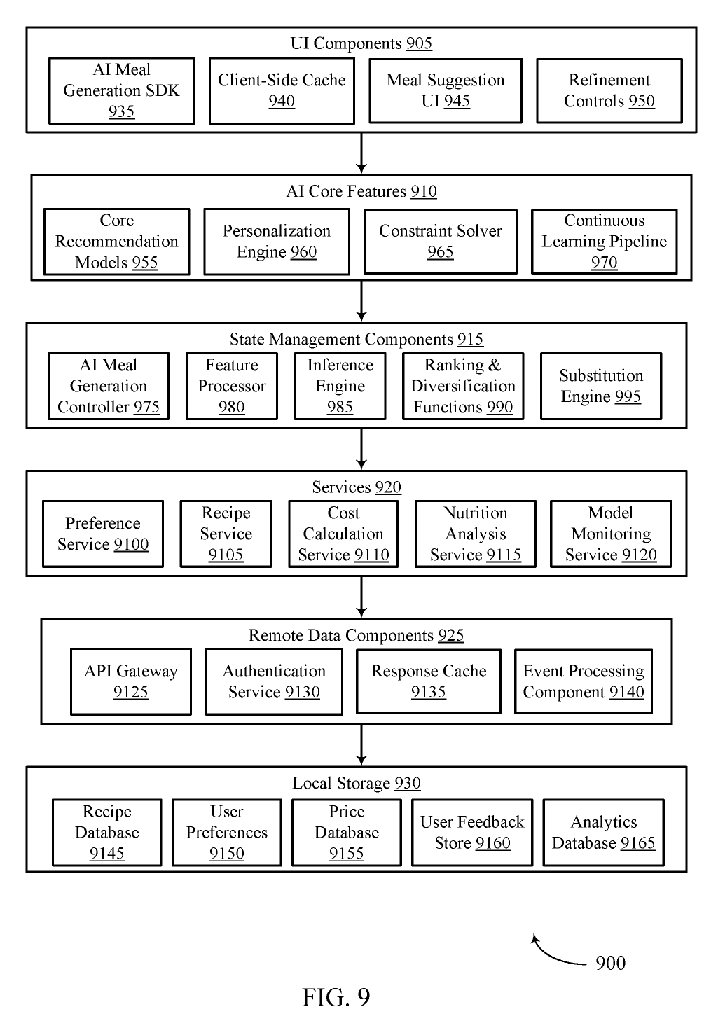

FIG. 9 shows an example of an AI system 900 that supports an interactive grocery store platform in accordance with one or more aspects of the present disclosure. In some examples, the AI system 900 may implement, or be implemented by, aspects of the system 100, the flowchart 200, the flowchart 300, the flowchart 400, the flowchart 500, the flowchart 600, the flowchart 700, and the mobile application 800. The AI system 900 may include UI components 905, AI core features 910, state management components 915, services 920, remote data components 925, and local storage 930. In some instances, aspects of the AI system 900 may be implemented by a content platform 125 as described with reference to FIG. 1. For example, the AI system 900 may be an example of, or may perform the similar features as the AI component 145.

The UI components 905 may include an AI meal generation software development kit (SDK) 935. The AI meal generation SDK 935 may include one or more tools and/or resources that support AI meal generation, for example AI meal generation in accordance with an AI meal generation flow 205 as illustrated in FIG. 2. For instance, the AI meal generation SDK 935 may support functions of the inference engine 2200, as illustrated in FIG. 2. In some aspects, the AI meal generation SDK 935 may include one or more debuggers, one or more compilers, one or more software libraries, one or more software frameworks, or any combination thereof.

The UI components 905 may include a client-side cache 940. The client-side cache 940 may temporarily store recipes or other data at a user device, for example a user device accessing the mobile application 2180 as described with reference to FIG. 2. In some cases, the client-side cache 940 may support a caching strategy. The caching strategy may support a multi-level cache for frequently accessed recipes (e.g., recipes frequently accessed at the user device), intelligent media caching based on usage patterns, offline-first design for core functionalities, or any combination thereof. For example, the AI system 900 may monitor or access usage data for recipes at the user device. The usage data may include a viewing duration for recipes, a frequency with which the user device accesses the recipe, user recipe selection patterns (e.g., or recipe rejection patterns), or any combination thereof. In some cases, the caching strategy may implement intelligent caching to reduce latency and API costs.

The UI components 905 may include a meal suggestion UI 945. The meal suggestion UI 945 may display suggested meals to a user. For example, the AI system 900 may generate one or more suggested meals in accordance with the AI meal generation flow 205 as illustrated in FIG. 2, and the meal suggestion UI 945 may display the suggested meals in a format that is accessible to the user. The meal suggestion UI 945 may facilitate user interaction with recipes, user selection of recipes, browsing of suggested recipes, or any other user interactions with suggested recipes. In some aspects, the meal suggestion UI 945 may be associated with the mobile application 2180 as described with reference to FIG. 2.

The UI components 905 may include refinement controls 950. The refinement controls 950 may support operations of the user refinement flow 2105 and the feedback collection flow 2150 as described with reference to FIG. 2. For instance, the refinement controls 950 may allow a user to input a refinement request or user feedback to refine or update suggested meals. The refinement controls 950 may support dynamic preference adaptation, incremental refinement of one or more ML models, or both. In some aspects, the refinement controls 950 may support input of user preferences and settings, such as via the initial location setup flow 340 of FIG. 3, the dietary preferences configuration flow 440 of FIG. 4, and the budget setup flow 535 of FIG. 5.

The AI core features 910 may include one or more core recommendation models 955. The one or more core recommendation models 955 may, for example, be applied by the inference engine 2200 as described with reference to FIG. 2. The one or more core recommendation models may be ML or AI models for recommending meals (e.g., recipes) to a user. The one or more core recommendation models may include a recipe embedding model, a user preference model, a recipe generation model, or any combination thereof. In some examples, the recipe embedding model may be a transformer-based encoder-decoder model that takes recipe texts, ingredient lists, images, user reviews, or any combination thereof as inputs and outputs recipe embedding vectors (e.g., 256-dimensional recipe embedding vectors). The recipe embedding model may be trained via contrastive learning with triplet loss, and the recipe embedding model may be fine-tuned via domain adaptation for culinary specificity. In some cases, the user preference model may be a deep factorization machine model that takes user attributes, interaction history, explicit preferences, or any combination thereof as inputs and outputs a user preference vector and preference strength indicators. The user preference model may be trained via supervised learning with multi-task objectives, and the user preference model may be personalized for a specific user through continuous online learning from user interactions. In some examples, the recipe generation model may be a conditional variational autoencoder model that takes desired attributes, ingredients, constraints (e.g., constraints based on user preferences or a user budget), or any combination thereof as inputs and outputs one or more structured recipes with associated ingredients, steps, and metadata. The recipe generation model may be trained via teacher forcing with reconstruction loss, and constrain satisfaction may be implemented via a differentiable constraint layer.

The AI core features 910 may include a personalization engine 960. The personalization engine 960 may use user feedback, refinements, preferences, and/or settings input via the refinement controls 950 to personalize meal suggestions for a particular user. In some aspects, the personalization engine 960 may be implemented by or in association with the inference engine 2200 as described with reference to FIG. 2. In some cases, the personalization engine 960 may adapt the one or more core recommendation models 955 based on implicit or explicit user feedback.

The AI core features 910 may include a constraint solver 965. The constraint solver 965 may ensure recipes suggested by the core recommendation models 955 satisfy one or more user constraints, such as budget constraints and dietary preferences input via the refinement controls 950. In some aspects, the constraint solver 965 may be implemented by or in association with the inference engine 2200 as described with reference to FIG. 2. In some cases, the constraint solver 965 may support dynamic modification of recipes to meet user constraints.

The AI core features 910 may include a continuous learning pipeline 970. The continuous learning pipeline may include interconnected data processing and modeling steps to support training of the core recommendation models 955. For instance, the continuous learning pipeline 970 may support adaptation of the core recommendation models 955 based on user feedback, such as user feedback input via the refinement controls 950 or implicit user feedback (e.g., based on monitoring user data). In some aspects, the continuous learning pipeline 970 may include a behavioral preference learning pipeline that processes implicit signals from user interactions to build a multi-dimensional preference model without explicit ratings or feedback from users.

The state management components 915 may support handling and storage of user data and UI controls, as well as reactions of the AI system 900 to changes in user data or user inputs. The state management components 915 may include an AI meal generation controller 975, which may regulate generation of meal suggestions by the AI core features 910 in response to user inputs via the UI components 905. For instance, the AI meal generation controller 975 may be an example of the AI controller 2190 as described with reference to FIG. 2. The state management components 915 may also include a feature processor 980 and an inference engine 985, which may be examples of the feature processor 2195 and the inference engine 2200 described with reference to FIG. 2. For instance, the feature processor 980 may process user preferences and settings to generate ML model inputs (e.g., feature vectors), and the inference engine 985 may generate AI meal suggestions using the AI core features 910.

The state management components 915 may support ranking and diversification functions 990, for example ranking and diversification of meal suggestions as performed by an inference engine as described with reference to FIG. 2. For instance, the ranking and diversification functions 990 may rank and diversify results (e.g., output meal suggestions) of the core recommendation models 955. For instance, the ranking and diversification functions 990 may support ranking of meal suggestion based on relevance to a user in accordance with user settings or preferences. The state managements components 915 may further include a substitution engine 995, which may regulate substitution of ingredients in suggested meals based on user constraints (e.g., budget preferences, allergens, dietary restrictions). The substitution engine 995 may recommend ingredient replacements based on functional properties, flavor profiles, dietary restrictions, budget constraints, or any combination thereof.

The services 920 may perform various functions (e.g., provide various services) associated with the AI system 900. The services 920 may include a preference service 9100, a recipe service 9105, a cost calculation service 9110, and a model monitoring service 9120, which may be examples of the preference service 2205, the recipe service 2210, the cost service 2215, and the monitoring service 2220 as described with reference to FIG. 2. For instance, the preference service 9100 may manage user preferences (e.g., location preferences, dietary preferences, and budget preferences such as those established in FIGS. 3–5), and the recipe service 2210 may manage a database of candidate recipes that the AI system 900 may suggest to a user or that the user may search via a recipe search flow 740 as described with reference to FIG. 7. The cost calculation service 9110 may fetch ingredient costs from local stores and calculate costs of suggested meals. The model monitoring service 9120 may dynamically adapt the core recommendation models 955 based on implicit and explicit user feedback.

In some cases, the services 920 may include a nutrition analysis service 9115, which may adjust meal plans for nutritional completeness across multiple meals and household members. The nutrition analysis service 9115 may fetch and/or analyze nutritional data for ingredients or recipes. In some cases, the nutrition analysis service 9115 may provide a nutritional summary for suggested meals.

The remote data components 925 may include components for accessing data from sources stored at remote servers or storage systems (e.g., external to a user device). The remote data components 925 may include an API gateway 9125, which may manage interactions between the UI components 905 and the AI core features 910, the state managements components 915, and the services 920. That is, the API gateway 9125 may manage interactions between user requests via a mobile application and backend components of the AI system 900. The API gateway 9125 may be an example of the API gateway 2185 as described with reference to FIG. 2.

The remote data components 925 may further include an authentication service 9130, which may perform user authentication and authorization to improve security of the AI system 900. In some cases, the authentication service 9130 may support authentication methods such as multi-factor authentication associated with a user email and/or password, Open Authorization (OAuth) integration with major providers, biometric authentication (e.g., on supported user devices), or any combination thereof. The authentication service 9130 may also implement an authorization model including role-based access for shared households (e.g., parental controls), a fine-grained permission system for family accounts, secure delegation for shopping permissions, or any combination thereof. The authentication service 9130 and the AI system 900 may further support data protection through local data security measures (e.g., an encrypted local database with secure key storage, biometric authentication for sensitive operations, secure credential storage using a platform keychain), transit security measures (e.g., transport layer security (TLS) 1.3 for API communications, certificate pinning for API endpoints, payload encryption for sensitive data), server-side security measures (e.g., tokenized user identification, reduced personal data storage, regular security audits and penetration testing), or any combination thereof. The authentication service 9130 and the AI system 900 may further support secure payment information handling through tokenization of payment details, refraining from persistently storing complete payment information, secure handoff to payment processors, and compliance with payment card industry (PCI) data security standard (DSS) requirements.

The remote data components 925 may include a response cache 9135, which may temporarily store results of queries associated with accessing remote data sources (e.g., APIs). For instance, the AI system 900 may access a recipe database to suggest recipes or a grocery store database to obtain cost information for ingredients at local stores, and the response cache 9135 may temporarily store data obtained from these remote data sources.

The remote data components 925 may include an event processing component 9140, which may access remote data sources to determine special occasions and events that may influence user preferences or suggested meals. For instance, the event processing component 9140 may access calendar data to determine holidays or other special occasions to support special occasion handling by the AI system 900. In some aspects, the event processing component 9140 may obtain data to support dynamic recommendations and adjustments to meal suggestions by the AI system 900, such as seasonal ingredient prioritization, weather-appropriate suggestions, and time-of-day relevance adjustments.

The local storage 930 may include data (e.g., user-specific data) stored at a user device. For instance, the local storage 930 may include a recipe database 9145, user preferences 9150, a price database 9155, a user feedback store 9160, and an analytics database 9165. The local storage 930 may, in some aspects, persistently store data associated with a user at a user device of the user, such as the location, dietary preference, and budget settings as described with reference to FIGS. 3–5. For instance, the recipe database 9145 may store recipes suggested to or saved by a user. In some cases, the analytics database 9165 may store implicit user feedback and data associated with analysis of user interactions with recipes, such as interaction pattern analysis, view duration tracking, selection behavior modeling, abandonment pattern detection, or any combination thereof.

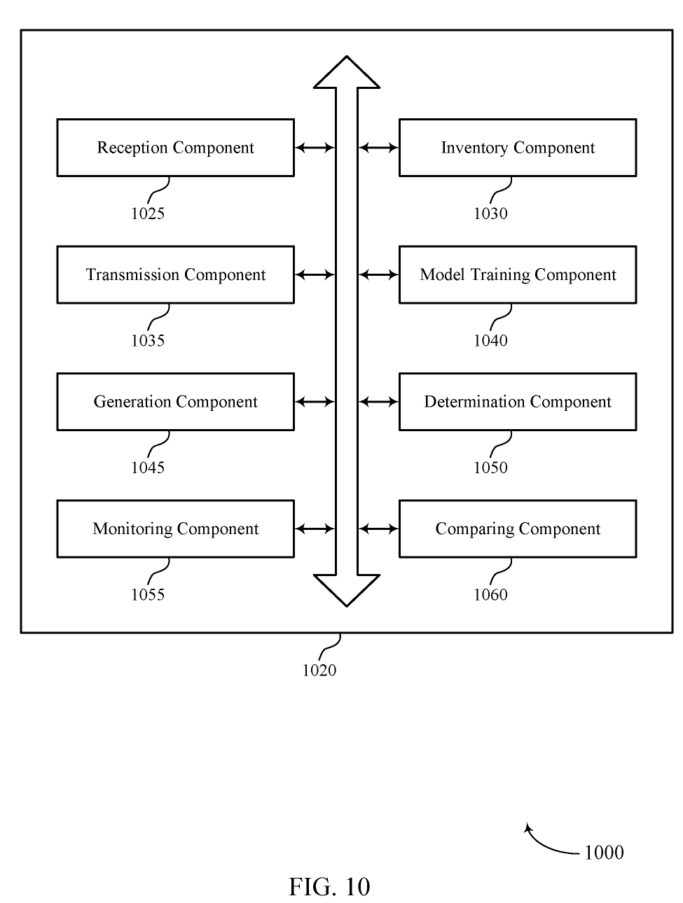

FIG. 10 shows a block diagram 1000 of a content platform 1020 that supports an interactive grocery platform in accordance with aspects of the present disclosure. The content platform 1020 may be an example of aspects of a content platform 125 as described with reference to FIG. 1, or other content platforms as described herein. The content platform 1020, or various components thereof, may be an example of means for performing (e.g., to cause the content platform 1020 to perform) various aspects of interactive grocery platform as described herein. For example, the content platform 1020 may include a reception component 1025, an inventory component 1030, a transmission component 1035, a model training component 1040, a generation component 1045, a determination component 1050, a monitoring component 1055, a comparing component 1060, or any combination thereof. Each of these components, or components of subcomponents thereof (e.g., one or more processors, one or more memories), may communicate, directly or indirectly, with one another (e.g., via one or more buses).

The reception component 1025 may be configured to support receiving, from a first device associated with a first user, a first message including one or more user preferences and location information. The inventory component 1030 may be configured to support obtaining, by the server, inventory information for one or more grocery stores based on the one or more user preferences and the location information. The transmission component 1035 may be configured to support transmitting, to the first device, a second message indicating one or more recipes based on obtaining the inventory information, the one or more recipes associated with the one or more user preferences. In some examples, the reception component 1025 may be configured to support receiving, from the first device, a third message indicating a selection of one or more recipes to include in a meal plan. The model training component 1040 may be configured to support training, by the server, a model for generating meal plans to the first user based on interactions between the first user and the one or more recipes and receiving the third message. In some examples, the transmission component 1035 may be configured to support transmitting, to the first device, a fourth message indicating a second meal plan based on the trained model. The generation component 1045 may be configured to support generating, by the server, a shopping list based at least in part receiving the third message, the fourth message, or both and obtaining the inventory information for the one or more grocery stores, the shopping list including the inventory information for each of the one or more grocery stores. In some examples, the transmission component 1035 may be configured to support transmitting, to the first device, a fifth message indicating the shopping list generated for the first user.

In some examples, the reception component 1025 may be configured to support receiving, from the first device, a sixth message including the location information associated with the first device.

In some examples, the reception component 1025 may be configured to support receiving, from the first device, a seventh message indicating to purchase one or more items included in the shopping list and a grocery store of the one or more grocery stores from which to purchase the one or more items. In some examples, the transmission component 1035 may be configured to support transmitting, by the server, an eighth message to a second server associated with the grocery store, the eighth message indicating to purchase the one or more items.

In some examples, the reception component 1025 may be configured to support receiving, by the server, a ninth message from the second server that includes tracking information for an order associated with the purchase of the one or more items. In some examples, the transmission component 1035 may be configured to support transmitting, to the first device, a tenth message indicating the tracking information for the order.

In some examples, the determination component 1050 may be configured to support determining a flavor profile associated with the first user based on receiving the third message, where the second meal plan includes one or more recipes associated with the flavor profile.

In some examples, the transmission component 1035 may be configured to support transmitting, to the first device, an eleventh message indicating media content for preparing the one or more recipes selected by the first user.

In some examples, the media content includes voice dictation of one or more steps for preparing an individual recipe of the one or more recipes selected by the first user.

In some examples, the media content includes a video tutorial of one or more steps for preparing an individual recipe of the one or more recipes selected by the first user.

In some examples, the determination component 1050 may be configured to support determining a skill level associated with the one or more recipes included in the meal plan, where the second meal plan includes recipes having the skill level.

In some examples, the reception component 1025 may be configured to support receiving, by the server, a twelfth message indicating feedback from the first user regarding the meal plan and the second meal plan. In some examples, the model training component 1040 may be configured to support training, by the server, the model based on receiving the twelfth message. In some examples, the transmission component 1035 may be configured to support transmitting, to the first device, a thirteenth message indicating one or more third recipes based on training the model.

In some examples, the monitoring component 1055 may be configured to support monitoring, by the server, interactions between the first user of the content platform and the one or more recipes based on transmitting the second message to the first device, where training the model is based on monitoring the interactions.

In some examples, the transmission component 1035 may be configured to support transmitting, to the first device, a fourteenth message indicating one or more ingredient substitution recommendations for one or more selected recipes based on the one or more user preferences.

In some examples, the reception component 1025 may be configured to support receiving, by the server, a fifteenth message indicating a listing of pantry items for the first user. In some examples, the generation component 1045 may be configured to support refraining from including the listing of pantry items in the shopping list.

In some examples, the generation component 1045 may be configured to support refraining from duplicative ingredients from two or more selected recipes in the shopping list.

In some examples, the reception component 1025 may be configured to support receiving, by the server, a sixteenth message indicating a brand preference, a size preference, or both for items to include in the shopping list, where the shopping list includes brands and sizes of items that are based on the brand preference, the size preference, or both.

In some examples, the comparing component 1060 may be configured to support comparing a price of items included in the shopping list for one or more grocery stores. In some examples, the determination component 1050 may be configured to support determining a grocery store of the one or more grocery stores having a lowest cost for the items included in the shopping list, where the fifth message includes an indication of the grocery store having the lowest cost.

In some examples, the determination component 1050 may be configured to support determining at least two grocery stores of the one or more grocery stores having a lowest cost for respective items included in the shopping list, where the fifth message includes an indication of the at least two grocery stores having the lowest cost for respective items.

In some examples, the fifth message includes an indication of an aisle of each item included in the shopping list for each of the one or more grocery stores.

In some examples, the one or more user preferences includes dietary restrictions, a budget range, or both.

In some examples, the determination component 1050 may be configured to support determining, based on the inventory information, an availability of each item included in the shopping list for each grocery store of the one or more grocery stores and a price of each item included in the shopping list for each grocery store of the one or more grocery stores, where the fifth message includes the availability of each item and the price of each item included in the shopping list for each grocery store of the one or more grocery stores.

In some examples, the one or more user preferences includes user preferences for a set of multiple members of a household.

In some examples, the shopping list includes a price of available items for each of the one or more grocery stores.

In some examples, the shopping list includes a price per person per meal for each selected recipe for each of the one or more grocery stores.

In some examples, the model training component 1040 may be configured to support training the model based on one or more environmental changes associated with the location information associated with the first device.

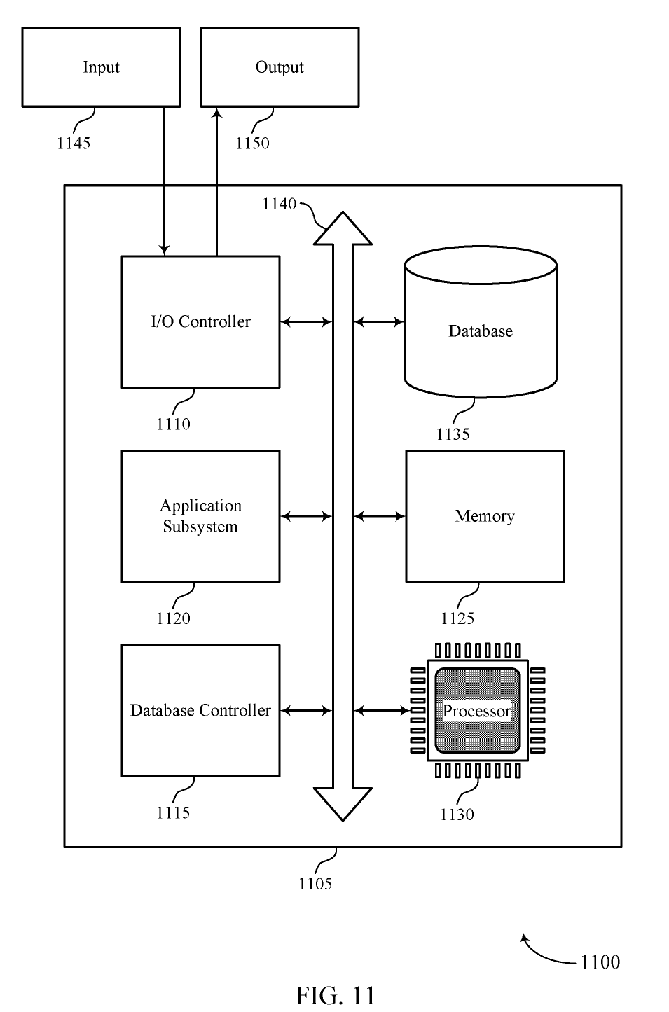

FIG. 11 shows a diagram of a system 1100 including a device 1105 that supports an interactive grocery platform in accordance with aspects of the present disclosure. The device 1105 may be an example of or include components of a device as described herein. The device 1105 may include components for bi-directional data communications including components for transmitting and receiving communications, such as an application subsystem, 1120, an I/O controller, such as an I/O controller 1110, a database controller 1115, at least one memory 1125, at least one processor 1130, and a database 1135. These components may be in electronic communication or otherwise coupled (e.g., operatively, communicatively, functionally, electronically, electrically) via one or more buses (e.g., a bus 1140).

The I/O controller 1110 may manage input signals 1145 and output signals 1150 for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. In other cases, the I/O controller 1110 may represent or interact with a modem, a keyboard, a mouse, a touchscreen, or a similar device. In some cases, the I/O controller 1110 may be implemented as part of a processor 1130. In some examples, a user may interact with the device 1105 via the I/O controller 1110 or via hardware components controlled by the I/O controller 1110.

The database controller 1115 may manage data storage and processing in a database 1135. In some cases, a user may interact with the database controller 1115. In other cases, the database controller 1115 may operate automatically without user interaction. The database 1135 may be an example of a single database, a distributed database, multiple distributed databases, a data store, a data lake, or an emergency backup database.

Memory 1125 may include random-access memory (RAM) and read-only memory (ROM). The memory 1125 may store computer-readable, computer-executable software including instructions that, when executed, cause at least one processor 1130 to perform various functions described herein. In some cases, the memory 1125 may contain, among other things, a basic I/O system (BIOS) which may control basic hardware or software operation such as the interaction with peripheral components or devices. The memory 1125 may be an example of a single memory or multiple memories. For example, the device 1105 may include one or more memories 1125.

The processor 1130 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 1130 may be configured to operate a memory array using a memory controller. In other cases, a memory controller may be integrated into the processor 1130. The processor 1130 may be configured to execute computer-readable instructions stored in at least one memory 1125 to perform various functions (e.g., functions or tasks supporting interactive grocery platform). The processor 1130 may be an example of a single processor or multiple processors. For example, the device 1105 may include one or more processors 1130.

For example, the application subsystem 1120 may be configured to support receiving, from a first device associated with a first user, a first message including one or more user preferences and location information. The application subsystem 1120 may be configured to support obtaining, by the server, inventory information for one or more grocery stores based on the one or more user preferences and the location information. The application subsystem 1120 may be configured to support transmitting, to the first device, a second message indicating one or more recipes based on obtaining the inventory information, the one or more recipes associated with the one or more user preferences. The application subsystem 1120 may be configured to support receiving, from the first device, a third message indicating a selection of one or more recipes to include in a meal plan. The application subsystem 1120 may be configured to support training, by the server, a model for generating meal plans to the first user based on interactions between the first user and the one or more recipes and receiving the third message. The application subsystem 1120 may be configured to support transmitting, to the first device, a fourth message indicating a second meal plan based on the trained model. The application subsystem 1120 may be configured to support generating, by the server, a shopping list based at least in part receiving the third message, the fourth message, or both and obtaining the inventory information for the one or more grocery stores, the shopping list including the inventory information for each of the one or more grocery stores. The application subsystem 1120 may be configured to support transmitting, to the first device, a fifth message indicating the shopping list generated for the first user.

By including or configuring the application subsystem 1120 in accordance with examples as described herein, the device 1105 may support techniques for streamlining processes and reducing time and expenses incurred due to otherwise burdensome grocery planning, grocery shopping, and the meal preparation processes.

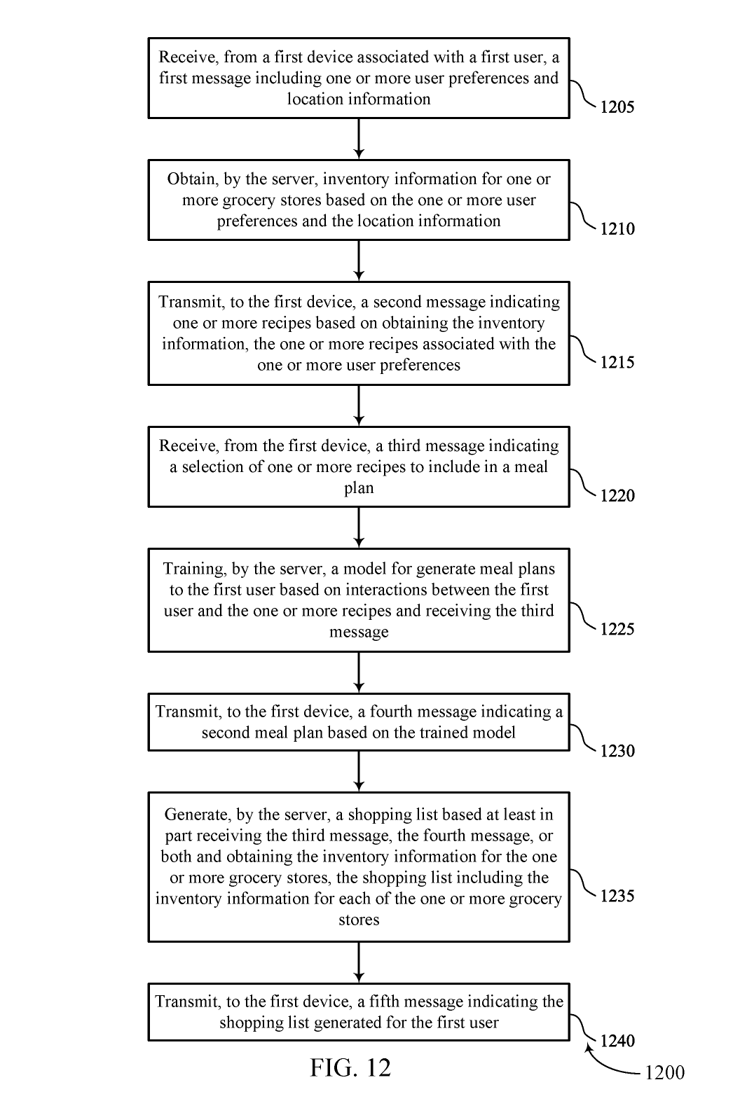

FIG. 12 shows a flowchart illustrating a method 1200 that supports an interactive grocery platform in accordance with aspects of the present disclosure. The operations of the method 1200 may be implemented by a content platform or its components as described herein. For example, the operations of the method 1200 may be performed by a content platform as described with reference to FIGS. 1-11. In some examples, a content platform may execute a set of instructions to control the functional elements of the content platform to perform the described functions. Additionally, or alternatively, the content platform may perform aspects of the described functions using special-purpose hardware.

At 1205, the method may include receiving, from a first device associated with a first user, a first message including one or more user preferences and location information. The operations of 1205 may be performed in accordance with examples as disclosed herein. In some examples, aspects of the operations of 1205 may be performed by a reception component 1025.

At 1210, the method may include obtaining, by the server, inventory information for one or more grocery stores based on the one or more user preferences and the location information. The operations of 1210 may be performed in accordance with examples as disclosed herein. In some examples, aspects of the operations of 1210 may be performed by an inventory component 1030.

At 1215, the method may include transmitting, to the first device, a second message indicating one or more recipes based on obtaining the inventory information, the one or more recipes associated with the one or more user preferences. The operations of 1215 may be performed in accordance with examples as disclosed herein. In some examples, aspects of the operations of 1215 may be performed by a transmission component 1035.

At 1220, the method may include receiving, from the first device, a third message indicating a selection of one or more recipes to include in a meal plan. The operations of 1220 may be performed in accordance with examples as disclosed herein. In some examples, aspects of the operations of 1220 may be performed by a reception component 1025.

At 1225, the method may include training, by the server, a model for generating meal plans to the first user based on interactions between the first user and the one or more recipes and receiving the third message. The operations of 1225 may be performed in accordance with examples as disclosed herein. In some examples, aspects of the operations of 1225 may be performed by a model training component 1040.

At 1230, the method may include transmitting, to the first device, a fourth message indicating a second meal plan based on the trained model. The operations of 1230 may be performed in accordance with examples as disclosed herein. In some examples, aspects of the operations of 1230 may be performed by a transmission component 1035.

At 1235, the method may include generating, by the server, a shopping list based at least in part receiving the third message, the fourth message, or both and obtaining the inventory information for the one or more grocery stores, the shopping list including the inventory information for each of the one or more grocery stores. The operations of 1235 may be performed in accordance with examples as disclosed herein. In some examples, aspects of the operations of 1235 may be performed by a generation component 1045.

At 1240, the method may include transmitting, to the first device, a fifth message indicating the shopping list generated for the first user. The operations of 1240 may be performed in accordance with examples as disclosed herein. In some examples, aspects of the operations of 1240 may be performed by a transmission component 1035.

A server associated with a content platform is described. The server associated with a content platform may include one or more memories storing processor executable code, and one or more processors coupled with the one or more memories. The one or more processors may individually or collectively be operable to execute the code to cause the server associated with a content platform to receive, from a first device associated with a first user, a first message including one or more user preferences and location information, obtain, by the server, inventory information for one or more grocery stores based on the one or more user preferences and the location information, transmit, to the first device, a second message indicating one or more recipes based on obtaining the inventory information, the one or more recipes associated with the one or more user preferences, receive, from the first device, a third message indicating a selection of one or more recipes to include in a meal plan, training, by the server, a model for generating meal plans to the first user based on interactions between the first user and the one or more recipes and receiving the third message, transmit, to the first device, a fourth message indicating a second meal plan based on the trained model, generate, by the server, a shopping list based at least in part receiving the third message, the fourth message, or both and obtaining the inventory information for the one or more grocery stores, the shopping list including the inventory information for each of the one or more grocery stores, and transmit, to the first device, a fifth message indicating the shopping list generated for the first user.

Another server associated with a content platform is described. The server associated with a content platform may include means for receiving, from a first device associated with a first user, a first message including one or more user preferences and location information, means for obtaining, by the server, inventory information for one or more grocery stores based on the one or more user preferences and the location information, means for transmitting, to the first device, a second message indicating one or more recipes based on obtaining the inventory information, the one or more recipes associated with the one or more user preferences, means for receiving, from the first device, a third message indicating a selection of one or more recipes to include in a meal plan, means for training, by the server, a model for generating meal plans to the first user based on interactions between the first user and the one or more recipes and receiving the third message, means for transmitting, to the first device, a fourth message indicating a second meal plan based on the trained model, means for generating, by the server, a shopping list based at least in part receiving the third message, the fourth message, or both and obtaining the inventory information for the one or more grocery stores, the shopping list including the inventory information for each of the one or more grocery stores, and means for transmitting, to the first device, a fifth message indicating the shopping list generated for the first user.

A non-transitory computer-readable medium storing code is described. The code may include instructions executable by one or more processors to receive, from a first device associated with a first user, a first message including one or more user preferences and location information, obtain, by the server, inventory information for one or more grocery stores based on the one or more user preferences and the location information, transmit, to the first device, a second message indicating one or more recipes based on obtaining the inventory information, the one or more recipes associated with the one or more user preferences, receive, from the first device, a third message indicating a selection of one or more recipes to include in a meal plan, training, by the server, a model for generating meal plans to the first user based on interactions between the first user and the one or more recipes and receiving the third message, transmit, to the first device, a fourth message indicating a second meal plan based on the trained model, generate, by the server, a shopping list based at least in part receiving the third message, the fourth message, or both and obtaining the inventory information for the one or more grocery stores, the shopping list including the inventory information for each of the one or more grocery stores, and transmit, to the first device, a fifth message indicating the shopping list generated for the first user.

Some examples of the method, server associated with a content platform, and non-transitory computer-readable medium described herein may further include operations, features, means, or instructions for receiving, from the first device, a sixth message including the location information associated with the first device.

Some examples of the method, server associated with a content platforms, and non-transitory computer-readable medium described herein may further include operations, features, means, or instructions for receiving, from the first device, a seventh message indicating to purchase one or more items included in the shopping list and a grocery store of the one or more grocery stores from which to purchase the one or more items and transmitting, by the server, an eighth message to a second server associated with the grocery store, the eighth message indicating to purchase the one or more items.

Some examples of the method, server associated with a content platforms, and non-transitory computer-readable medium described herein may further include operations, features, means, or instructions for receiving, by the server, a ninth message from the second server that includes tracking information for an order associated with the purchase of the one or more items and transmitting, to the first device, a tenth message indicating the tracking information for the order.

Some examples of the method, server associated with a content platforms, and non-transitory computer-readable medium described herein may further include operations, features, means, or instructions for determining a flavor profile associated with the first user based on receiving the third message, where the second meal plan includes one or more recipes associated with the flavor profile.

Some examples of the method, server associated with a content platform, and non-transitory computer-readable medium described herein may further include operations, features, means, or instructions for transmitting, to the first device, an eleventh message indicating media content for preparing the one or more recipes selected by the first user.

In some examples of the method, server associated with a content platform, and non-transitory computer-readable medium described herein, the media content includes voice dictation of one or more steps for preparing an individual recipe of the one or more recipes selected by the first user.

In some examples of the method, server associated with a content platform, and non-transitory computer-readable medium described herein, the media content includes a video tutorial of one or more steps for preparing an individual recipe of the one or more recipes selected by the first user.

Some examples of the method, server associated with a content platforms, and non-transitory computer-readable medium described herein may further include operations, features, means, or instructions for determining a skill level associated with the one or more recipes included in the meal plan, where the second meal plan includes recipes having the skill level.

Some examples of the method, server associated with a content platforms, and non-transitory computer-readable medium described herein may further include operations, features, means, or instructions for receiving, by the server, a twelfth message indicating feedback from the first user regarding the meal plan and the second meal plan, training, by the server, the model based on receiving the twelfth message, and transmitting, to the first device, a thirteenth message indicating one or more third recipes based on training the model.

Some examples of the method, server associated with a content platforms, and non-transitory computer-readable medium described herein may further include operations, features, means, or instructions for monitoring, by the server, interactions between the first user of the content platform and the one or more recipes based on transmitting the second message to the first device, where training the model may be based on monitoring the interactions.

Some examples of the method, server associated with a content platforms, and non-transitory computer-readable medium described herein may further include operations, features, means, or instructions for transmitting, to the first device, a fourteenth message indicating one or more ingredient substitution recommendations for one or more selected recipes based on the one or more user preferences.

Some examples of the method, server associated with a content platforms, and non-transitory computer-readable medium described herein may further include operations, features, means, or instructions for receiving, by the server, a fifteenth message indicating a listing of pantry items for the first user and refraining from including the listing of pantry items in the shopping list.

Some examples of the method, server associated with a content platform, and non-transitory computer-readable medium described herein may further include operations, features, means, or instructions for refraining from duplicative ingredients from two or more selected recipes in the shopping list.

Some examples of the method, server associated with a content platforms, and non-transitory computer-readable medium described herein may further include operations, features, means, or instructions for receiving, by the server, a sixteenth message indicating a brand preference, a size preference, or both for items to include in the shopping list, where the shopping list includes brands and sizes of items that may be based on the brand preference, the size preference, or both.

Some examples of the method, server associated with a content platforms, and non-transitory computer-readable medium described herein may further include operations, features, means, or instructions for comparing a price of items included in the shopping list for one or more grocery stores and determining a grocery store of the one or more grocery stores having a lowest cost for the items included in the shopping list, where the fifth message includes an indication of the grocery store having the lowest cost.

Some examples of the method, server associated with a content platforms, and non-transitory computer-readable medium described herein may further include operations, features, means, or instructions for determining at least two grocery stores of the one or more grocery stores having a lowest cost for respective items included in the shopping list, where the fifth message includes an indication of the at least two grocery stores having the lowest cost for respective items.

In some examples of the method, server associated with a content platform, and non-transitory computer-readable medium described herein, the fifth message includes an indication of an aisle of each item included in the shopping list for each of the one or more grocery stores.

In some examples of the method, server associated with a content platform, and non-transitory computer-readable medium described herein, the one or more user preferences includes dietary restrictions, a budget range, or both.

Some examples of the method, server associated with a content platforms, and non-transitory computer-readable medium described herein may further include operations, features, means, or instructions for determining, based on the inventory information, an availability of each item included in the shopping list for each grocery store of the one or more grocery stores and a price of each item included in the shopping list for each grocery store of the one or more grocery stores, where the fifth message includes the availability of each item and the price of each item included in the shopping list for each grocery store of the one or more grocery stores.

In some examples of the method, server associated with a content platform, and non-transitory computer-readable medium described herein, the one or more user preferences includes user preferences for a set of multiple members of a household.

In some examples of the method, server associated with a content platform, and non-transitory computer-readable medium described herein, the shopping list includes a price of available items for each of the one or more grocery stores.

In some examples of the method, server associated with a content platform, and non-transitory computer-readable medium described herein, the shopping list includes a price per person per meal for each selected recipe for each of the one or more grocery stores.

Some examples of the method, server associated with a content platform, and non-transitory computer-readable medium described herein may further include operations, features, means, or instructions for training the model based on one or more environmental changes associated with the location information associated with the first device.

The following provides an overview of aspects of the present disclosure:

Aspect 1: A method by a server associated with a content platform, comprising: receiving, from a first device associated with a first user, a first message including one or more user preferences and location information; obtaining, by the server, inventory information for one or more grocery stores based at least in part on the one or more user preferences and the location information; transmitting, to the first device, a second message indicating one or more recipes based at least in part on obtaining the inventory information, the one or more recipes associated with the one or more user preferences; receiving, from the first device, a third message indicating a selection of one or more recipes to include in a meal plan; training, by the server, a model for generating meal plans to the first user based at least in part on interactions between the first user and the one or more recipes and receiving the third message; transmitting, to the first device, a fourth message indicating a second meal plan based at least in part on the trained model; generating, by the server, a shopping list based at least in part receiving the third message, the fourth message, or both and obtaining the inventory information for the one or more grocery stores, the shopping list comprising the inventory information for each of the one or more grocery stores; and transmitting, to the first device, a fifth message indicating the shopping list generated for the first user.

Aspect 2: The method of aspect 1, further comprising: receiving, from the first device, a sixth message comprising the location information associated with the first device.

Aspect 3: The method of any of aspects 1 through 2, further comprising: receiving, from the first device, a seventh message indicating to purchase one or more items included in the shopping list and a grocery store of the one or more grocery stores from which to purchase the one or more items; and transmitting, by the server, an eighth message to a second server associated with the grocery store, the eighth message indicating to purchase the one or more items.

Aspect 4: The method of aspect 3, further comprising: receiving, by the server, a ninth message from the second server that includes tracking information for an order associated with the purchase of the one or more items; and transmitting, to the first device, a tenth message indicating the tracking information for the order.

Aspect 5: The method of any of aspects 1 through 4, further comprising: determining a flavor profile associated with the first user based at least in part on receiving the third message, wherein the second meal plan comprises one or more recipes associated with the flavor profile.

Aspect 6: The method of any of aspects 1 through 5, further comprising: transmitting, to the first device, an eleventh message indicating media content for preparing the one or more recipes selected by the first user.

Aspect 7: The method of aspect 6, wherein the media content comprises voice dictation of one or more steps for preparing an individual recipe of the one or more recipes selected by the first user.

Aspect 8: The method of any of aspects 6 through 7, wherein the media content comprises a video tutorial of one or more steps for preparing an individual recipe of the one or more recipes selected by the first user.

Aspect 9: The method of any of aspects 1 through 8, further comprising: determining a skill level associated with the one or more recipes included in the meal plan, wherein the second meal plan comprises recipes having the skill level.

Aspect 10: The method of any of aspects 1 through 9, further comprising: receiving, by the server, a twelfth message indicating feedback from the first user regarding the meal plan and the second meal plan; training, by the server, the model based at least in part on receiving the twelfth message; and transmitting, to the first device, a thirteenth message indicating one or more third recipes based at least in part on training the model.

Aspect 11: The method of any of aspects 1 through 10, further comprising: monitoring, by the server, interactions between the first user of the content platform and the one or more recipes based at least in part on transmitting the second message to the first device, wherein training the model is based at least in part on monitoring the interactions.

Aspect 12: The method of any of aspects 1 through 11, further comprising: transmitting, to the first device, a fourteenth message indicating one or more ingredient substitution recommendations for one or more selected recipes based at least in part on the one or more user preferences.

Aspect 13: The method of any of aspects 1 through 12, further comprising: receiving, by the server, a fifteenth message indicating a listing of pantry items for the first user; and refraining from including the listing of pantry items in the shopping list.

Aspect 14: The method of any of aspects 1 through 13, further comprising: refraining from duplicative ingredients from two or more selected recipes in the shopping list.

Aspect 15: The method of any of aspects 1 through 14, further comprising: receiving, by the server, a sixteenth message indicating a brand preference, a size preference, or both for items to include in the shopping list, wherein the shopping list includes brands and sizes of items that are based at least in part on the brand preference, the size preference, or both.

Aspect 16: The method of any of aspects 1 through 15, further comprising: comparing a price of items included in the shopping list for one or more grocery stores; and determining a grocery store of the one or more grocery stores having a lowest cost for the items included in the shopping list, wherein the fifth message comprises an indication of the grocery store having the lowest cost.

Aspect 17: The method of any of aspects 1 through 16, further comprising: determining at least two grocery stores of the one or more grocery stores having a lowest cost for respective items included in the shopping list, wherein the fifth message comprises an indication of the at least two grocery stores having the lowest cost for respective items.

Aspect 18: The method of any of aspects 1 through 17, wherein the fifth message includes an indication of an aisle of each item included in the shopping list for each of the one or more grocery stores.

Aspect 19: The method of any of aspects 1 through 18, wherein the one or more user preferences comprises dietary restrictions, a budget range, or both.

Aspect 20: The method of aspect 19, further comprising: determining, based at least in part on the inventory information, an availability of each item included in the shopping list for each grocery store of the one or more grocery stores and a price of each item included in the shopping list for each grocery store of the one or more grocery stores, wherein the fifth message comprises the availability of each item and the price of each item included in the shopping list for each grocery store of the one or more grocery stores.

Aspect 21: The method of any of aspects 19 through 20, wherein the one or more user preferences comprises user preferences for a plurality of members of a household.

Aspect 22: The method of any of aspects 1 through 21, wherein the shopping list comprises a price of available items for each of the one or more grocery stores.

Aspect 23: The method of any of aspects 1 through 22, wherein the shopping list comprises a price per person per meal for each selected recipe for each of the one or more grocery stores.

Aspect 24: The method of any of aspects 1 through 23, further comprising: training the model based at least in part on one or more environmental changes associated with the location information associated with the first device.

Aspect 25: A server associated with a content platform comprising one or more memories storing processor-executable code, and one or more processors coupled with the one or more memories and individually or collectively operable to execute the code to cause the server associated with a content platform to perform a method of any of aspects 1 through 24.

Aspect 26: A server associated with a content platform comprising at least one means for performing a method of any of aspects 1 through 24.

Aspect 27: A non-transitory computer-readable medium storing code the code comprising instructions executable by one or more processors to perform a method of any of aspects 1 through 24.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method by a server associated with a content platform, comprising:
receiving, from a first device associated with a first user, a first message including one or more user preferences and location information;
obtaining, by the server, inventory information for one or more grocery stores based at least in part on the one or more user preferences and the location information;
transmitting, to the first device, a second message indicating one or more recipes based at least in part on obtaining the inventory information, the one or more recipes associated with the one or more user preferences;
receiving, from the first device, a third message indicating a selection of one or more recipes to include in a meal plan;
training, by the server, a model for generating meal plans to the first user based at least in part on interactions between the first user and the one or more recipes and receiving the third message;
transmitting, to the first device, a fourth message indicating a second meal plan based at least in part on the trained model;
generating, by the server, a shopping list based at least in part receiving the third message, the fourth message, or both and obtaining the inventory information for the one or more grocery stores, the shopping list comprising the inventory information for each of the one or more grocery stores; and
transmitting, to the first device, a fifth message indicating the shopping list generated for the first user.

2. The method of claim 1, further comprising:
receiving, from the first device, a sixth message comprising the location information associated with the first device.

3. The method of claim 1, further comprising:
receiving, from the first device, a seventh message indicating to purchase one or more items included in the shopping list and a grocery store of the one or more grocery stores from which to purchase the one or more items; and
transmitting, by the server, an eighth message to a second server associated with the grocery store, the eighth message indicating to purchase the one or more items.

4. The method of claim 3, further comprising:
receiving, by the server, a ninth message from the second server that includes tracking information for an order associated with the purchase of the one or more items; and
transmitting, to the first device, a tenth message indicating the tracking information for the order.

5. The method of claim 1, further comprising:
determining a flavor profile associated with the first user based at least in part on receiving the third message, wherein the second meal plan comprises one or more recipes associated with the flavor profile.

6. The method of claim 1, further comprising:
transmitting, to the first device, an eleventh message indicating media content for preparing the one or more recipes selected by the first user, wherein the media content comprises:
voice dictation of one or more steps for preparing an individual recipe of the one or more recipes selected by the first user; or a video tutorial of one or more steps for preparing an individual recipe of the one or more recipes selected by the first user.

7. The method of claim 1, further comprising:
determining a skill level associated with the one or more recipes included in the meal plan, wherein the second meal plan comprises recipes having the skill level.

8. The method of claim 1, further comprising:
receiving, by the server, a twelfth message indicating feedback from the first user regarding the meal plan and the second meal plan;
training, by the server, the model based at least in part on receiving the twelfth message; and
transmitting, to the first device, a thirteenth message indicating one or more third recipes based at least in part on training the model.

9. The method of claim 1, further comprising:
monitoring, by the server, interactions between the first user of the content platform and the one or more recipes based at least in part on transmitting the second message to the first device, wherein training the model is based at least in part on monitoring the interactions.

10. The method of claim 1, further comprising:
transmitting, to the first device, a fourteenth message indicating one or more ingredient substitution recommendations for one or more selected recipes based at least in part on the one or more user preferences.

11. The method of claim 1, further comprising:
receiving, by the server, a fifteenth message indicating a listing of pantry items for the first user; and
refraining from including the listing of pantry items in the shopping list.

12. The method of claim 1, further comprising:
refraining from duplicative ingredients from two or more selected recipes in the shopping list.

13. The method of claim 1, further comprising:
receiving, by the server, a sixteenth message indicating a brand preference, a size preference, or both for items to include in the shopping list, wherein the shopping list includes brands and sizes of items that are based at least in part on the brand preference, the size preference, or both.

14. The method of claim 1, further comprising:
comparing a price of items included in the shopping list for one or more grocery stores; and
determining a grocery store of the one or more grocery stores having a lowest cost for the items included in the shopping list, wherein the fifth message comprises an indication of the grocery store having the lowest cost.

15. The method of claim 1, further comprising:
determining at least two grocery stores of the one or more grocery stores having a lowest cost for respective items included in the shopping list, wherein the fifth message comprises an indication of the at least two grocery stores having the lowest cost for respective items.

16. The method of claim 1, wherein the fifth message includes an indication of an aisle of each item included in the shopping list for each of the one or more grocery stores.

17. The method of claim 1, wherein the one or more user preferences comprises dietary restrictions, a budget range, or both.

18. The method of claim 17, further comprising:
determining, based at least in part on the inventory information, an availability of each item included in the shopping list for each grocery store of the one or more grocery stores and a price of each item included in the shopping list for each grocery store of the one or more grocery stores, wherein the fifth message comprises the availability of each item and the price of each item included in the shopping list for each grocery store of the one or more grocery stores.

19. The method of claim 17, wherein the one or more user preferences comprises user preferences for a plurality of members of a household.

20. The method of claim 1, wherein the shopping list comprises:
a price of available items for each of the one or more grocery stores; or a price per person per meal for each selected recipe for each of the one or more grocery stores.
